(19) United States
(12) Patent Application Publication
(10) Pub. No.: US 2026/0331796 A1
(43) Pub. Date: Oct. 22, 2026

(54) CONNECTOR DEVICE

(71) Applicant: JAPAN AVIATION ELECTRONICS INDUSTRY, LIMITED, Tokyo (JP)

(72) Inventor: Osamu HASHIGUCHI, Tokyo (JP)

(73) Assignee: JAPAN AVIATION ELECTRONICS INDUSTRY, LIMITED, Tokyo (JP)

(21) Appl. No.: 19/568,569

(22) Filed: Mar. 16, 2026

(30) Foreign Application Priority Data
Apr. 21, 2025 (JP) 2025-069820

(51) Int. Cl. H01R 12/70; H01R 12/71; H01R 13/627; H01R 13/642; H01R 24/62

(52) U.S. Cl. CPC H01R 12/7023; H01R 12/716; H01R 13/6273; H01R 13/642; H01R 24/62

(57) ABSTRACT

An aspect of the present invention provides a connector device including a first connector and a second connector. The first connector has a first inner straight and a first outer straight. The second connector has a second inner straight and a second outer straight. When the first connector and the second connector are mated with each other, the first inner straight and the second inner straight face each other in the width direction, the first outer straight and the second outer straight face each other in the width direction, and the second connector is formed with an upper space and a lower space. The upper space is larger than a distance between the first inner straight and the second inner straight in the width direction. The lower space is larger than a distance between the first outer straight and the second outer straight in the width direction.

### CROSS REFERENCE TO RELATED APPLICATIONS

This application is based on and claims priority under 35 U.S.C. §119 to Japanese Patent Application No. JP 2025-069820 filed Apr. 21, 2025, the content of which is incorporated herein in its entirety by reference.

### BACKGROUND OF THE INVENTION

This invention relates to a connector device comprising a first connector and a second connector mateable with each other.

For example, this type of connector device is disclosed in JP2016-178004A (Patent Document 1), the content of which is incorporated herein by reference.

Referring to FIG. 61, Patent Document 1 discloses a two-piece connector (connector device) 90 comprising a plug connector (first connector) 92 and a receptacle connector (second connector) 96 mateable with each other. The first connector 92 is provided with two lock portions 94 which are located at opposite sides thereof in a width direction (left-right direction in FIG. 61), respectively. The second connector 96 is provided with two locked portions 98. In a mating operation, an operator firstly mates the first connector 92 and the second connector 96 with each other. Then, the operator engages the lock portions 94 with the locked portions 98, respectively. As described above, the connector device 90 of Patent Document 1 comprises two lock mechanisms which are located at opposite sides thereof in the width direction, respectively, and thereby its mated state can be reliably kept.

According to an existing connector device such as the connector device 90 of Patent Document 1, the operator of the mating operation sometimes ceases the mating operation after only one of the lock mechanisms is locked. There is a demand to reduce the number of the lock mechanisms to one so that this problem can be solved. The connector device with only one lock mechanism may have one of two structures, namely a first structure and a second structure. According to the first structure, the lock mechanism is provided at the middle of the connector device in the width direction. According to the second structure, the lock mechanism is provided at only one of opposite ends of the connector device in the width direction. According to the first structure, the size (thickness) of the connector device in a direction perpendicular to the width direction becomes large. The second structure should be selected if the connector device cannot be made thicker for some reason.

### SUMMARY OF THE INVENTION

It is therefore an object of the present invention to provide a connector device having a structure which is suitable to provide a lock mechanism only at one of opposite ends of the connector device in a width direction.

According to an instance in which a lock mechanism is provided only at a locked side which is one of opposite ends thereof in the width direction, when the first connector receives a force which removes the first connector from the second connector, a free side of the first connector, or a side which is not provided with the lock mechanism, is easily detached. In other words, the thus-formed first connector tends to be easily turned around the locked side. If the connector device has reduced clearance between the first connector and the second connector so that a turn of the first connector is prevented, it becomes difficult to remove the first connector from the second connector. As a result, the connector device might be damaged during removal of the first connector. In order to solve the aforementioned problem, the inventor of the present invention has invented a structure which prevents a turn around the locked side while allowing a turn around the free side. Since the turn around the free side is allowed, the first connector can be easily removed after unlock of the mated state. Accordingly, this structure also prevents damage of the connector device which might be caused because of an excessive force during removal of the first connector. More specifically, the present invention provides the connector device described below.

An aspect of the present invention provides a connector device comprising a first connector and a second connector. The first connector is mateable with the second connector, which is located below the first connector in an up-down direction, along the up-down direction. The first connector has a main portion and a predetermined side. The main portion extends along a vertical plane defined by the up-down direction and a width direction perpendicular to the up-down direction. The predetermined side is located on one of opposite ends of the main portion in the width direction. The predetermined side has a key portion and a lock mechanism. The key portion extends in the up-down direction and protrudes from the main portion in a thickness direction perpendicular to both the up-down direction and the width direction. The key portion has a first inner straight and a first outer straight. The first inner straight is located on an inner side of the key portion in the width direction and linearly extends along the up-down direction. The first outer straight is located on an outer side of the key portion in the width direction and linearly extends along the up-down direction. The first inner straight is at least partially located below the first outer straight. The lock mechanism has a lock portion and a support portion which is resiliently deformable. The support portion supports the lock portion. The lock portion is movable at least in the width direction in accordance with resilient deformation of the support portion. The second connector is formed with a main accommodation portion and a predetermined accommodation portion. The main accommodation portion is configured to accommodate the main portion of the first connector. The predetermined accommodation portion is configured to accommodate the predetermined side of the first connector. The predetermined accommodation portion includes a key-receiving portion. The key-receiving portion is configured to receive the key portion of the first connector. The key-receiving portion is provided with a second inner straight and a second outer straight. The second inner straight is located on an inner side of the key-receiving portion in the width direction and linearly extends along the up-down direction. The second outer straight is located on an outer side of the key-receiving portion in the width direction and linearly extends along the up-down direction. The second outer straight is at least partially located above the second inner straight. The predetermined accommodation portion is provided with a locked portion. The locked portion and the lock portion are together configured to lock a mated state where the first connector and the second connector are mated with each other. In the mated state, the first inner straight and the second inner straight are in contact with each other or face each other in the width direction, and the first outer straight and the second outer straight are in contact with each other or face each other in the width direction. In the mated state, the key-receiving portion is formed with an upper space and a lower space located therein. The upper space is located inward of the key portion in the width direction and is located above at least one of the first inner straight and the second inner straight. The upper space has a size in the width direction which is larger than a distance between the first inner straight and the second inner straight. The lower space is located outward of the key portion in the width direction and is located below at least one of the first outer straight and the second outer straight. The lower space has a size in the width direction which is larger than a distance between the first outer straight and the second outer straight.

The first connector of an aspect of the present invention has a locked side and a free side which are arranged in the width direction. The locked side is provided with the lock mechanism. The free side is not provided with the lock mechanism. When the first connector in the mated state is attempted to be turned around the locked side, the first inner straight and the second inner straight are pressed against each other, and the first outer straight and the second outer straight are pressed against each other. As a result, a turn around the locked side is prevented. However, another turn around the free side is allowed in a state where the mated state is unlocked because the upper space and the lower space are formed. The first connector can be removed from the second connector by moving the first connector upward or by turning the first connector around the free side after the mated state is unlocked. Thus, an aspect of the present invention provides a connector device having a structure which is suitable to provide the lock mechanism only at one of the opposite ends of the connector device in the width direction.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a connector device according to an embodiment of the present invention, wherein a first connector and a second connector of the connector device are in a separated state where they are separated from each other.

FIG. 2 is another perspective view showing the connector device of FIG. 1.

FIG. 3 is a perspective view showing the connector device of FIG. 1, wherein the first connector and the second connector are in a mated state where they are mated with each other.

FIG. 4 is a top view showing the first connector of the connector device of FIG. 1.

FIG. 5 is a bottom view showing the first connector of FIG. 4.

FIG. 6 is a side view showing the first connector of FIG. 4.

FIG. 7 is a cross-sectional view showing the first connector of FIG. 6, taken along line VII-VII.

FIG. 8 is a cross-sectional view showing the first connector of FIG. 4, taken along line VIII-VIII.

FIG. 9 is a top view showing the second connector of the connector device of FIG. 1.

FIG. 10 is a cross-sectional view showing the second connector of FIG. 9, taken along line X-X.

FIG. 11 is a cross-sectional view showing the second connector of FIG. 9, taken along line XI-XI.

FIG. 12 is a side view showing the connector device of FIG. 3, wherein a hidden outline of a predetermined side of the first connector is illustrated with dashed line.

FIG. 13 is a top view showing the connector device of FIG. 12.

FIG. 14 is another side view showing the connector device of FIG. 12, wherein boundaries between a hidden main accommodation portion, a hidden predetermined accommodation portion and a hidden additional accommodation portion of the second connector are illustrated with dashed line, and outlines of a hidden predetermined side and a hidden additional side of the first connector are illustrated with chain dotted line.

FIG. 15 is a cross-sectional view showing the connector device of FIG. 14, taken along line XV-XV.

FIG. 16 is a cross-sectional view showing the connector device of FIG. 13, taken along line XVI-XVI.

FIG. 17 is a cross-sectional view showing the connector device of FIG. 13, taken along line XVII-XVII.

FIG. 18 is a side view showing a positional relation between a key portion, an additional key portion, a lock portion, a key-receiving portion, an additional key-receiving portion and a locked portion of the connector device of FIG. 17, wherein outlines of the key portion and the additional key portion of the first connector which is turned around a free side by a predetermined angle is illustrated with dashed line.

FIG. 19 is a cross-sectional view showing the connector device of FIG. 13, taken along line XVI-XVI, wherein the first connector is turned around the free side.

FIG. 20 is a cross-sectional view showing the connector device of FIG. 13, taken along line XVII-XVII, wherein the first connector is turned around the free side.

FIG. 21 is a cross-sectional view showing the connector device of FIG. 13, taken along line XVI-XVI, wherein the first connector is turned around a locked side.

FIG. 22 is a cross-sectional view showing the connector device of FIG. 13, taken along line XVII-XVII, wherein the first connector is turned around the locked side.

FIG. 23 is a perspective view showing a connector device according to a first modification, wherein a first connector and a second connector of the connector device are in a separated state where they are separated from each other.

FIG. 24 is a perspective view showing the connector device of FIG. 23, wherein the first connector and the second connector are in a mated state where they are mated with each other.

FIG. 25 is a side view showing the first connector of the connector device of FIG. 23.

FIG. 26 is another side view showing the first connector of FIG. 25.

FIG. 27 is a cross-sectional view showing the first connector of FIG. 25, taken along line XXVII-XXVII.

FIG. 28 is a side view showing the second connector of the connector device of FIG. 23, wherein an outline of a projecting portion of the first connector in the mated state is illustrated with dashed line.

FIG. 29 is a top view showing the second connector of FIG. 28.

FIG. 30 is a cross-sectional view showing the second connector of FIG. 29, taken along line XXX-XXX.

FIG. 31 is a cross-sectional view showing the second connector of FIG. 29, taken along line XXXI-XXXI.

FIG. 32 is a top view showing the connector device of FIG. 24.

FIG. 33 is a cross-sectional view showing the connector device of FIG. 32, taken along line XXXIII-XXXIII.

FIG. 34 is a cross-sectional view showing the connector device of FIG. 32, taken along line XXXIV-XXXIV.

FIG. 35 is a cross-sectional view showing the connector device of FIG. 32, taken along line XXXIII-XXXIII, wherein the first connector is turned around a free side.

FIG. 36 is a cross-sectional view showing the connector device of FIG. 32, taken along line XXXIV-XXXIV, wherein the first connector is turned around the free side.

FIG. 37 is a cross-sectional view showing the connector device of FIG. 32, taken along line XXXIII-XXXIII, wherein the first connector is turned around a locked side.

FIG. 38 is a cross-sectional view showing the connector device of FIG. 32, taken along line XXXIV-XXXIV, wherein the first connector is turned around the locked side.

FIG. 39 is a perspective view showing a connector device according to a second modification, wherein a first connector and a second connector of the connector device are in a mated state where they are mated with each other.

FIG. 40 is a cross-sectional view showing the connector device of FIG. 39, wherein the illustrated cross-section corresponds to the cross-section of FIG. 16.

FIG. 41 is a cross-sectional view showing the connector device of FIG. 39, wherein the illustrated cross-section corresponds to the cross-section of FIG. 17.

FIG. 42 is a cross-sectional view showing the connector device of FIG. 39, wherein the illustrated cross-section corresponds to the cross-section of FIG. 20, and the first connector is turned around a free side.

FIG. 43 is a cross-sectional view showing the connector device of FIG. 39, wherein the illustrated cross-section corresponds to the cross-section of FIG. 22, and the first connector is turned around a locked side.

FIG. 44 is a perspective view showing a connector device according to a third modification, wherein a first connector and a second connector of the connector device are in a mated state where they are mated with each other.

FIG. 45 is a cross-sectional view showing the connector device of FIG. 44, wherein the illustrated cross-section corresponds to the cross-section of FIG. 16.

FIG. 46 is a cross-sectional view showing the connector device of FIG. 44, wherein the illustrated cross-section corresponds to the cross-section of FIG. 17.

FIG. 47 is a cross-sectional view showing the connector device of FIG. 44, wherein the illustrated cross-section corresponds to the cross-section of FIG. 20, and the first connector is turned around a free side.

FIG. 48 is a cross-sectional view showing the connector device of FIG. 44, wherein the illustrated cross-section corresponds to the cross-section of FIG. 22, and the first connector is turned around a locked side.

FIG. 49 is a cross-sectional view showing a connector device according to a fourth modification, wherein a first connector and a second connector of the connector device are in a mated state where they are mated with each other, and the illustrated cross-section corresponds to the cross-section of FIG. 16.

FIG. 50 is a cross-sectional view showing the connector device of FIG. 49, wherein the illustrated cross-section corresponds to the cross-section of FIG. 17.

FIG. 51 is a cross-sectional view showing the connector device of FIG. 49, wherein the illustrated cross-section corresponds to the cross-section of FIG. 20, and the first connector is turned around a free side.

FIG. 52 is a cross-sectional view showing the connector device of FIG. 49, wherein the illustrated cross-section corresponds to the cross-section of FIG. 22, and the first connector is turned around a locked side.

FIG. 53 is a perspective view showing a connector device according to a fifth modification, wherein a first connector and a second connector of the connector device are in a separated state where they are separated from each other.

FIG. 54 is a cross-sectional view showing the connector device of FIG. 53, wherein the first connector and the second connector are in a mated state where they are mated with each other, and the illustrated cross-section corresponds to the cross-section of FIG. 16.

FIG. 55 is a cross-sectional view showing the connector device of FIG. 54, wherein the illustrated cross-section corresponds to the cross-section of FIG. 17.

FIG. 56 is a perspective view schematically showing a connector device according to a sixth modification, wherein a first connector and a second connector of the connector device are in a separated state where they are separated from each other.

FIG. 57 is another perspective view schematically showing the connector device of FIG. 56.

FIG. 58 is a perspective view schematically showing the connector device of FIG. 56, wherein the first connector and the second connector are in a mated state where they are mated with each other.

FIG. 59 is a cross-sectional view schematically showing the connector device of FIG. 58, taken along line LIX-LIX.

FIG. 60 is a cross-sectional view schematically showing the connector device of FIG. 58, taken along line LX-LX.

FIG. 61 is a view showing a connector device of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

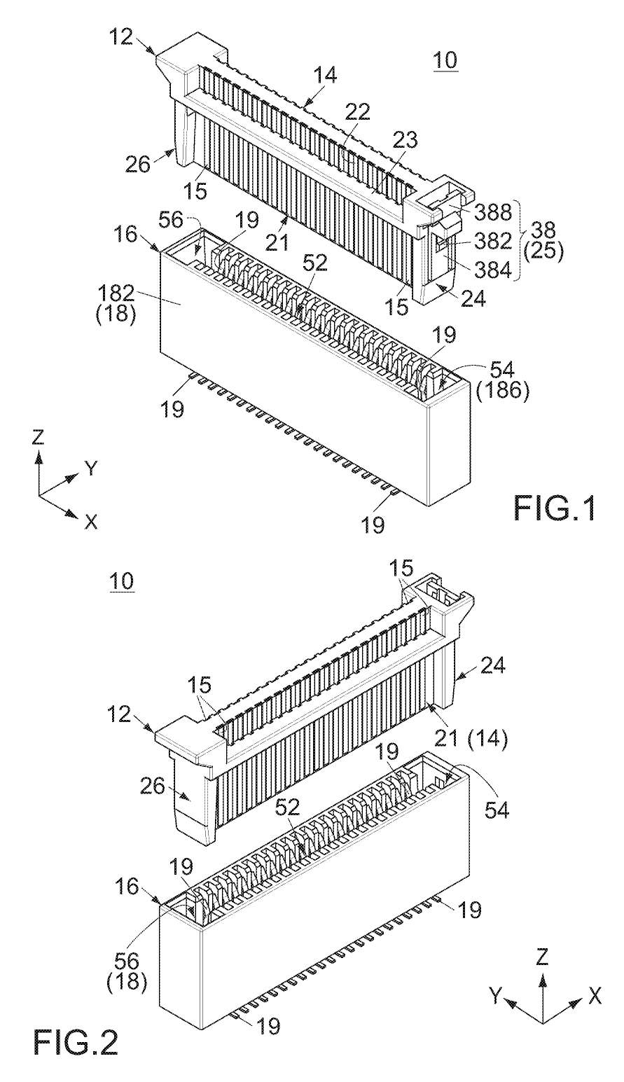

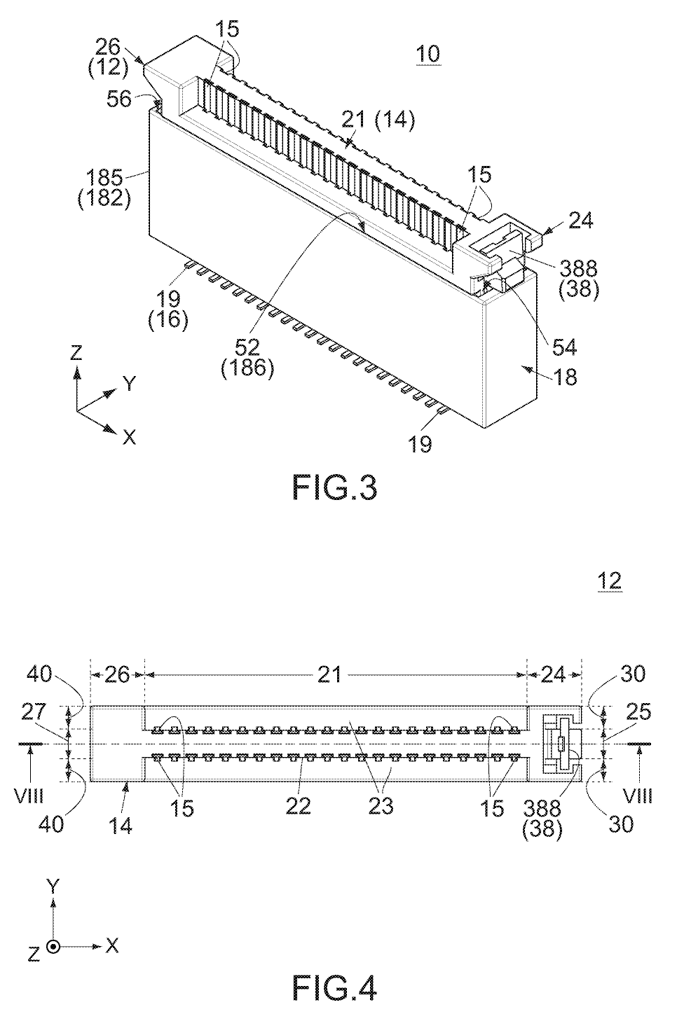

As shown in FIGS. 1-3, a connector device 10 according to an embodiment of the present invention comprises a first connector 12 and a second connector 16. The first connector 12 is mateable with the second connector 16, which is located below the first connector 12 in an up-down direction, along the up-down direction. The first connector 12 mated with the second connector 16 is removable upward. The connector device 10 shown in FIGS. 1 and 2 is in a separated state where the first connector 12 and the second connector 16 are separated from each other. The connector device 10 illustrated in FIG. 3 is in a mated state where the first connector 12 and the second connector 16 are mated with each other. The first connector 12 can be mated with the second connector 16 by a mating operation. The first connector 12 can be removed from the second connector 16 by a removing operation. The mating operation and the removing operation are usually performed by a human operator.

The up-down direction of the present embodiment is the Z-direction. In the present embodiment, “upward” means the positive Z-direction, and “downward” means the negative Z-direction. The words such as the up-down direction do not indicate the absolute positional relation relative to the ground but merely indicate a relative positional relation under a definition that the mating direction of the first connector 12 with the second connector 16 is the up-down direction.

The first connector 12 of the present embodiment is a plug. The second connector 16 of the present embodiment is a receptacle. Accordingly, the first connector 12 is partially received in the second connector 16 in the mated state. The first connector 12 is connected to a first object (not shown). The second connector 16 is connected to a second object (not shown). The first object of the present embodiment is a flat cable connected to a first device (not shown). The second object of the present embodiment is a circuit board incorporated in a second device (not shown). The first device and the second device are electrically connected with each other via the connector device 10 in the mated state.

The connector device 10 of the present embodiment consists of the aforementioned first connector 12 and the aforementioned second connector 16 and works as described above. However, the present invention is not limited thereto. For example, the connector device 10 may further comprise another member in addition to the first connector 12 and the second connector 16. The second connector 16 may be partially received in the first connector 12 in the mated state. The first object is not limited to the flat cable, and the second object is not limited to the circuit board. For example, the first object may be two or more wires separated from each other.

Hereafter, explanation will be made about the first connector 12 and the second connector 16 of the present embodiment.

Referring to FIG. 1, the first connector 12 of the present embodiment comprises a first holding member 14 made of insulator and first terminals 15 each made of conductor. The first holding member 14 of the present embodiment is a single member made of resin. Each of the first terminals 15 of the present embodiment is formed of a single metal plate. The first connector 12 of the present embodiment comprises only the aforementioned members. However, the present invention is not limited thereto. For example, the first connector 12 may further comprise another member in addition to the aforementioned members. The first holding member 14 may be formed of a plurality of members joined together. The number of the first terminal 15 may be one.

Referring to FIGS. 4-6, the first holding member 14 of the present embodiment extends long in a width direction perpendicular to the up-down direction. The width direction of the present embodiment is the X-direction. In the explanation about the first connector 12 described below, “inward” in the width direction means a position nearer to the center of the first connector 12 in the width direction or means a direction toward the center of the first connector 12 in the width direction, and “outward” in the width direction means a position farther from the center of the first connector 12 in the width direction or means a direction away from the center of the first connector 12 in the width direction.

The first holding member 14 has a rectangular shape as a whole in a vertical plane (XZ-plane) defined by the up-down direction and the width direction. The first holding member 14 has a height, or a size in the up-down direction, which is smaller than a width thereof, or a size in the width direction. The first holding member 14 has a thickness, or a size in a thickness direction perpendicular to both the up-down direction and the width direction, which is smaller than the height thereof. The thickness direction of the present embodiment is the Y-direction.

The first holding member 14 of the present embodiment is divided into three parts, namely a middle portion 21, a predetermined side 24 and an additional side 26. Thus, the first connector 12 of the present embodiment has the middle portion 21, the predetermined side 24 and the additional side 26. The middle portion 21 is located at the middle of the first holding member 14 in the width direction and extends along the vertical plane (XZ-plane) as a whole. The predetermined side 24 and the additional side 26 are located at opposite sides of the first holding member 14 in the width direction, respectively.

Referring to FIGS. 1 and 4 -7, the middle portion 21 of the present embodiment has a main portion 22 and two coupling portions 23. Thus, the first connector 12 of the present embodiment has the main portion 22 and the two coupling portions 23. The main portion 22 is located at the middle of the middle portion 21 in the thickness direction and extends along the vertical plane (XZ-plane). More specifically, the main portion 22 has a rectangular flat-plate shape extending along the vertical plane. The two coupling portions 23 are located on opposite sides of the main portion 22 in the thickness direction, respectively. Each of the coupling portions 23 has a rectangular rod shape extending along the width direction and couples the predetermined side 24 and the additional side 26 together in the width direction.

The predetermined side 24 and the additional side 26 which are coupled together as described above are located on opposite sides of the main portion 22 in the width direction, respectively. In other words, the predetermined side 24 is located on one of opposite ends of the main portion 22 in the width direction, and the additional side 26 is located on a remaining one of the opposite ends of the main portion 22 in the width direction.

The first holding member 14 of the present embodiment consists of the aforementioned four portions which are the main portion 22, a pair of the coupling portions 23, the predetermined side 24 and the additional side 26. However, the present invention is not limited thereto. For example, the first holding member 14 may further have another portion in addition to the aforementioned four portions. The additional side 26 and the coupling portions 23 may be provided as necessary. Thus, the first holding member 14 may have only the main portion 22 and the predetermined side 24.

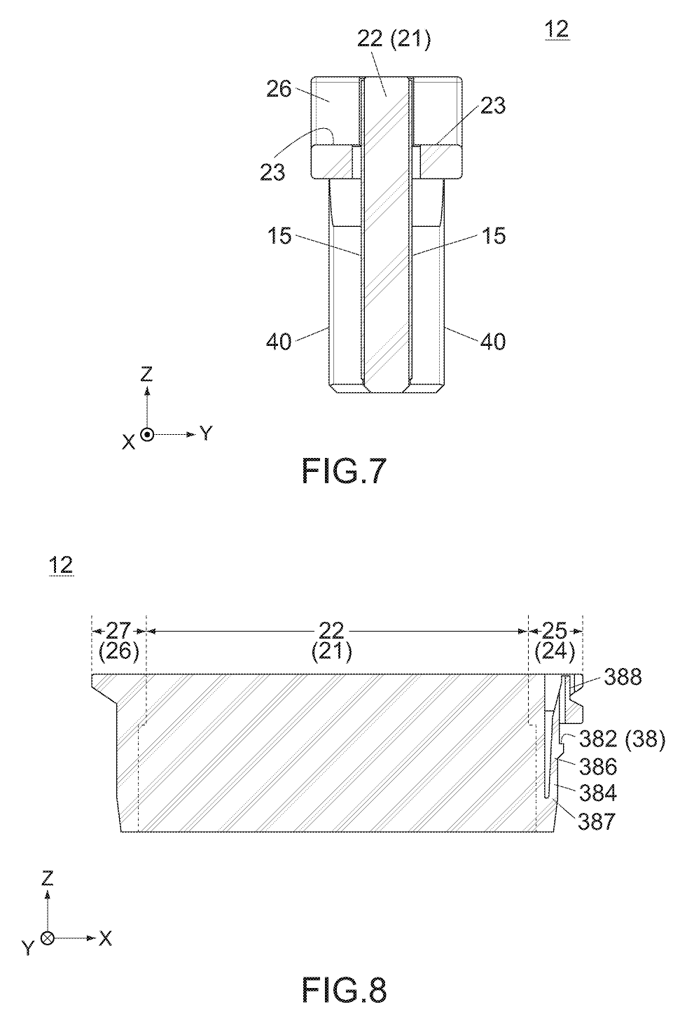

Referring to FIGS. 1, 4, 5 and 7, the first terminals 15 of the present embodiment are divided into two rows in the thickness direction. The two rows of the first terminals 15 are fixed on opposite surfaces of the main portion 22 in the thickness direction, respectively. Each of the first terminals 15 extends along the up-down direction. The first terminals 15 of each row are arranged at regular intervals in the width direction. As can be seen from the explanation described above, the main portion 22 is a part for holding the first terminals 15. The predetermined side 24 and the additional side 26 are parts used in the removing operation of the first connector 12 as described later.

The first connector 12 of the present embodiment has the aforementioned structure. Moreover, the first connector 12 has a mirror-symmetric structure with respect to the vertical plane (XZ-plane). However, the structure of the first connector 12 of the present invention is not specifically limited, provided that the first connector 12 has the main portion 22 and the predetermined side 24.

Referring to FIG. 1, the second connector 16 of the present embodiment comprises a second holding member 18 made of insulator and second terminals 19 each made of conductor. The second holding member 18 of the present embodiment is a single member made of resin. Each of the second terminals 19 of the present embodiment is formed of a single metal plate. The second connector 16 of the present embodiment comprises only the aforementioned members. However, the present invention is not limited thereto. For example, the second connector 16 may further comprise another member in addition to the aforementioned members. The second holding member 18 may be formed of a plurality of members joined together. The number of the second terminal 19 may be one.

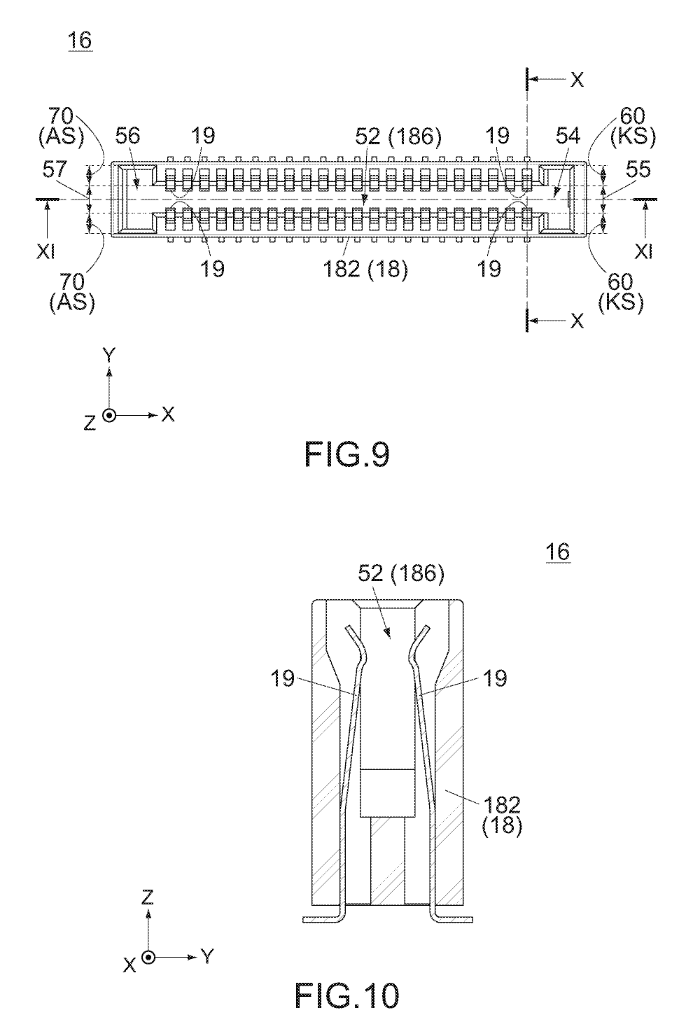

Referring to FIGS. 1 and 9, the second holding member 18 of the present embodiment extends long in the width direction. In the explanation about the second connector 16 described below, “inward” in the width direction means a position nearer to the center of the second connector 16 in the width direction or means a direction toward the center of the second connector 16 in the width direction, and “outward” in the width direction means a position farther from the center of the second connector 16 in the width direction or means a direction away from the center of the second connector 16 in the width direction.

The second holding member 18 has a rectangular shape as a whole in the vertical plane (XZ-plane). The second holding member 18 has a height, or a size in the up-down direction, which is smaller than a width thereof, or a size in the width direction. The second holding member 18 has a thickness, or a size in the thickness direction, which is smaller than the height thereof.

Referring to FIGS. 1, 9 and 10, the second holding member 18 has an outer wall 182. The outer wall 182 defines the outer circumference of the second holding member 18 in a horizontal plane (XY-plane) perpendicular to the up-down direction. The second holding member 18 is formed with a receiving space 186 located therein. The receiving space 186 is a space configured to receive a part of the first connector 12 and opens upward. The receiving space 186 is located at the middle of the second holding member 18 in the horizontal plane. The outer wall 182 of the present embodiment encloses the receiving space 186 in the horizontal plane with no gap.

Referring to FIGS. 9 and 14, the receiving space 186 of the present embodiment is divided into three spaces, namely a main accommodation portion 52, a predetermined accommodation portion 54 and an additional accommodation portion 56. Thus, the second connector 16 of the present embodiment is formed with the main accommodation portion 52, the predetermined accommodation portion 54 and the additional accommodation portion 56. The main accommodation portion 52 is located at the middle of the receiving space 186 in the width direction and extends along the vertical plane (XZ-plane). The predetermined accommodation portion 54 and the additional accommodation portion 56 are located at opposite sides of the receiving space 186 in the width direction, respectively. In other words, the predetermined accommodation portion 54 is located at one of opposite ends of the receiving space 186 in the width direction, and the additional accommodation portion 56 is located at a remaining one of the opposite ends of the receiving space 186 in the width direction.

Referring to FIG. 14, a lower part of the first connector 12 is received in the receiving space 186 in the mated state. In detail, a lower part of the main portion 22, a lower part of the predetermined side 24 and a lower part of the additional side 26 of the first connector 12 are received in the main accommodation portion 52, the predetermined accommodation portion 54 and the additional accommodation portion 56 of the second connector 16, respectively, in the mated state. As described above, the main accommodation portion 52 is configured to accommodate the main portion 22 of the first connector 12. The predetermined accommodation portion 54 is configured to accommodate the predetermined side 24 of the first connector 12. The additional accommodation portion 56 is configured to accommodate the additional side 26 of the first connector 12.

The receiving space 186 of the present embodiment consists of the aforementioned three spaces which are the main accommodation portion 52, the predetermined accommodation portion 54 and the additional accommodation portion 56. However, the present invention is not limited thereto. For example, the receiving space 186 may include another space in addition to the aforementioned three spaces. The additional accommodation portion 56 does not need to be provided in an instance in which the first connector 12 does not have the additional side 26. Thus, the receiving space 186 may include only the main accommodation portion 52 and the predetermined accommodation portion 54.

Referring to FIGS. 1, 9 and 10, the second terminals 19 of the present embodiment are divided into two rows in the thickness direction. The two rows of the second terminals 19 are fixed on two inner wall surfaces of the main accommodation portion 52 of the receiving space 186 in the thickness direction, respectively. Each of the second terminals 19 extends along the up-down direction as a whole. The second terminals 19 of each row are arranged at regular intervals in the width direction. Thus, the second terminals 19 are arranged so as to correspond to the first terminals 15 of the first connector 12, respectively. The main accommodation portion 52 is a space for holding the second terminals 19 so that each of the second terminals 19 can be brought into contact with the corresponding first terminal 15.

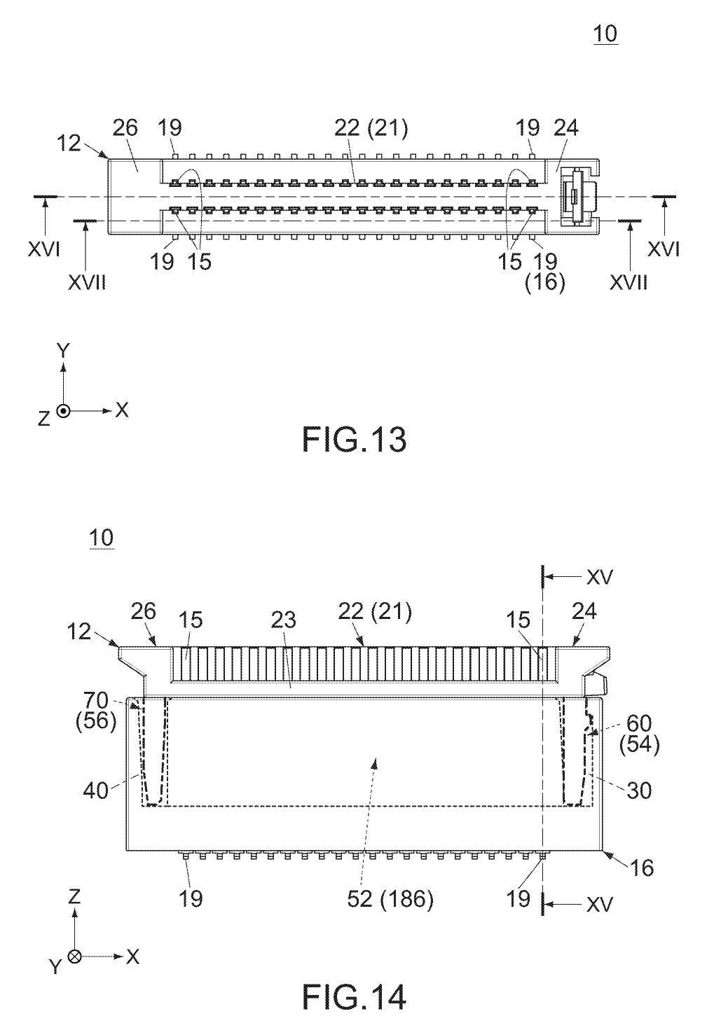

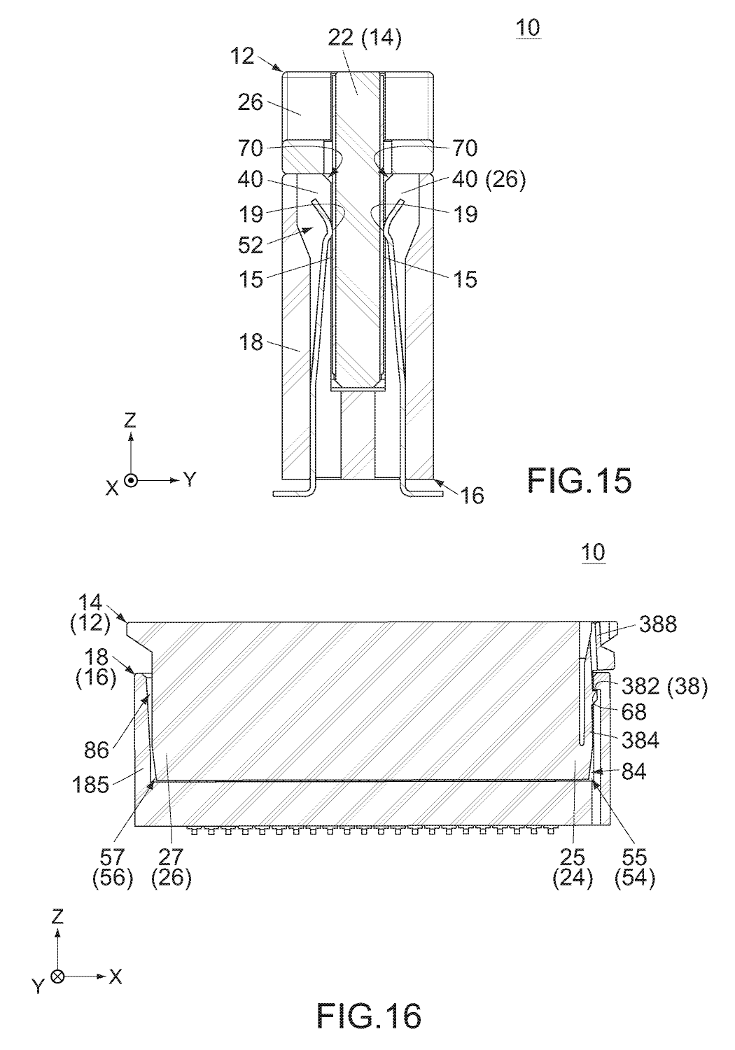

Referring to FIGS. 14 and 15, in the mated state, a lower part of the first connector 12 which is located below the coupling portion 23 is located in the receiving space 186 of the second connector 16, while an upper part of the first connector 12 which includes the coupling portion 23 and a part of the first connector 12 located above the coupling portion 23 projects upward from the second connector 16. In detail, in the mated state, the lower part of the main portion 22 of the first connector 12 is located in the main accommodation portion 52 of the receiving space 186. Referring to FIGS. 13 and 15, meanwhile, each of the first terminals 15 of the first connector 12 is brought into contact with the corresponding second terminal 19 of the second connector 16, and thereby the first device (not shown) connected to the first connector 12 is electrically connected with the second device (not shown) connected to the second connector 16.

Referring to FIG. 9, the second connector 16 of the present embodiment has the aforementioned structure. Moreover, the second connector 16 has a mirror-symmetric structure with respect to the vertical plane (XZ-plane). However, the structure of the second connector 16 of the present invention is not specifically limited, provided that the second connector 16 is formed with the main accommodation portion 52 and the predetermined accommodation portion 54.

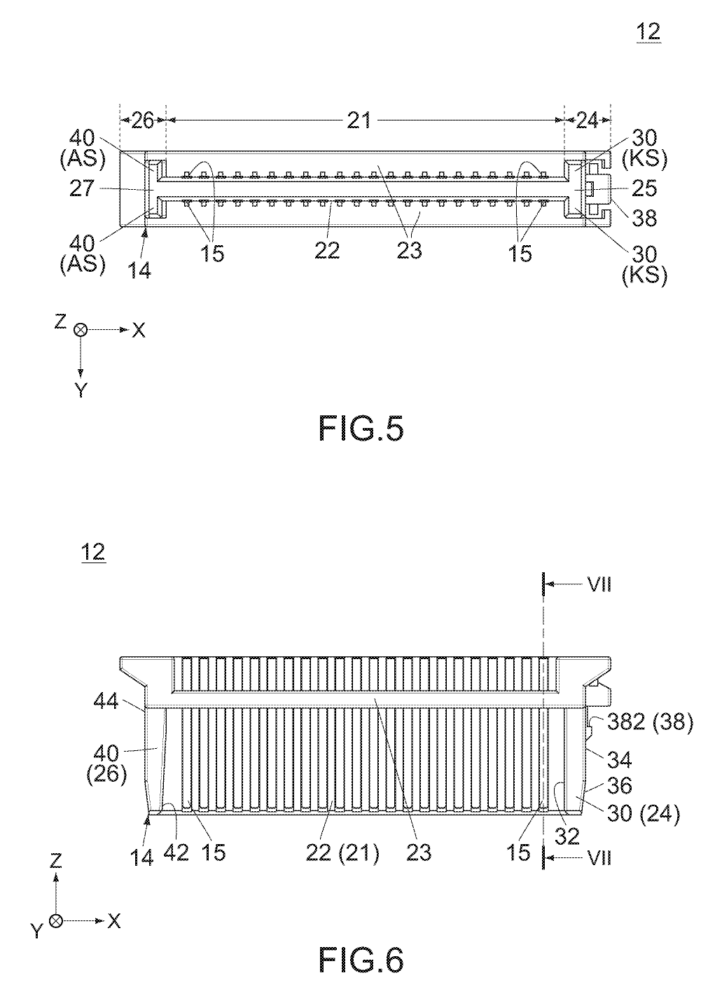

Hereafter, explanation will be made about the predetermined side 24 (see FIG. 5) of the first connector 12 (see FIG. 5) and the predetermined accommodation portion 54 of the second connector 16 of the present embodiment.

Referring to FIG. 5, the predetermined side 24 of the first connector 12 of the present embodiment has a base portion 25 and two key portions 30.

Referring to FIG. 5 together with FIGS. 4 and 6, the base portion 25 is located at the same position as the main portion 22 in the thickness direction. The two key portions 30 are located on opposite sides of the base portion 25 in the thickness direction, respectively, and extend in parallel to each other along the up-down direction. Thus, each of the key portions 30 extends in the up-down direction and protrudes from the main portion 22 in the thickness direction. The key portions 30 of the present embodiment protrude from opposite sides of the main portion 22 in the thickness direction. In detail, the two key portions 30 protrude from an end of the main portion 22 in the width direction so as to be away from each other in the thickness direction. Each of the key portions 30 does not overlap with the main portion 22 in the thickness direction. Moreover, the two key portions 30 have a mirror-symmetric structure with respect to the vertical plane (XZ-plane) and work similarly to each other.

The predetermined side 24 of the present embodiment has the aforementioned structure. However, the present invention is not limited thereto. For example, the predetermined side 24 may further have another portion in addition to the aforementioned portions. The base portion 25 may be provided as necessary. In an instance in which the base portion 25 is not provided, each of the key portions 30 may partially overlap with the main portion 22 in the thickness direction. The predetermined side 24 may have only one of the key portions 30 which protrudes from the main portion 22 in the thickness direction. This key portion 30 may include two key portions 30 which protrude from opposite sides of the main portion 22 in the thickness direction, respectively.

Referring to FIG. 9, the predetermined accommodation portion 54 of the second connector 16 of the present embodiment includes a base-receiving portion 55 and two key-receiving portions 60. Referring to FIG. 16, the base-receiving portion 55 is configured to receive the base portion 25 of the first connector 12. Referring to FIGS. 12 and 14, the key-receiving portions 60 are configured to receive the key portions 30 of the first connector 12, respectively.

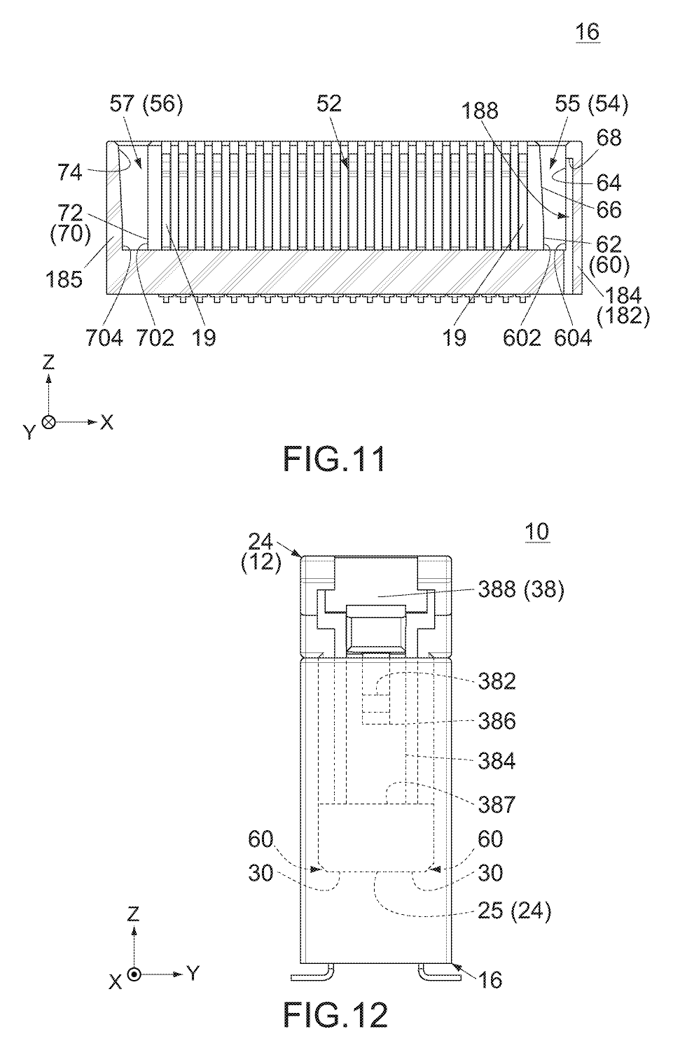

Referring to FIG. 9 together with FIG. 11, the base-receiving portion 55 is located at the same position as the main accommodation portion 52 in the thickness direction. The two key-receiving portions 60 are located on opposite sides of the base-receiving portion 55 in the thickness direction, respectively, and extend in parallel to each other along the up-down direction. Thus, each of the key-receiving portions 60 extends in the up-down direction and protrudes from the main accommodation portion 52 in the thickness direction. The key-receiving portions 60 of the present embodiment protrude from opposite sides of the main accommodation portion 52 in the thickness direction. In detail, the two key-receiving portions 60 protrude from an end of the main accommodation portion 52 in the width direction so as to be away from each other in the thickness direction. Each of the key-receiving portions 60 does not overlap with the main accommodation portion 52 in the thickness direction. Moreover, the two key-receiving portions 60 have a mirror-symmetric structure with respect to the vertical plane (XZ-plane) and work similarly to each other.

The predetermined accommodation portion 54 of the present embodiment has the aforementioned structure. However, the present invention is not limited thereto. For example, the predetermined accommodation portion 54 may further include another space in addition to the aforementioned spaces. In an instance in which the first connector 12 (see FIG. 5) does not have the base portion 25 (see FIG. 5), the base-receiving portion 55 does not need to be provided. In an instance in which the base-receiving portion 55 is not provided, each of the key-receiving portions 60 may partially overlap with the main accommodation portion 52 in the thickness direction. The predetermined accommodation portion 54 may include only one of the key-receiving portions 60 which protrudes from the main accommodation portion 52 in the thickness direction. This key-receiving portion 60 may include two key-receiving portions 60 which protrude from opposite sides of the main accommodation portion 52 in the thickness direction, respectively.

Referring to FIG. 8 together with FIG. 1, the base portion 25 of the first connector 12 of the present embodiment has a lock mechanism 38. Thus, the predetermined side 24 has the lock mechanism 38. The lock mechanism 38 of the present embodiment is located at an outer end of the base portion 25 in the width direction. The lock mechanism 38 has a lock portion 382, an operation portion 388 and a support portion 384 which is resiliently deformable. The support portion 384 supports the lock portion 382. The lock portion 382 is movable at least in the width direction in accordance with resilient deformation of the support portion 384. When the support portion 384 is in an initial state where the support portion 384 is not resiliently deformed, the upper surface of the lock portion 382 is a flat surface which extends in parallel to the horizontal plane.

Referring to FIG. 11, the base-receiving portion 55 of the second connector 16 of the present embodiment is provided with a locked portion 68. Thus, the predetermined accommodation portion 54 is provided with the locked portion 68. The locked portion 68 is located at an outer end of the base-receiving portion 55 in the width direction. In detail, the outer wall 182 of the second connector 16 has two end walls 184 and 185 which are located at opposite ends of the outer wall 182 in the width direction, respectively. The end wall 184 is located outward of the predetermined accommodation portion 54 in the width direction. The end wall 184 has a lower part formed with a depression 188 which is recessed outward in the width direction from an inner wall surface of the end wall 184. The locked portion 68 of the present embodiment is an upper surface of the depression 188 and is a flat surface which extends in parallel to the horizontal plane. The locked portion 68 is fixed to the second connector 16 so as to be unmovable relative to the second connector 16.

Referring to FIG. 16, during the mating operation, the lock portion 382 of the first connector 12 is moved below the locked portion 68 while being moved inward in the width direction in accordance with resilient deformation of the support portion 384. The support portion 384 returns to the initial state when the connector device 10 takes the mated state. Meanwhile, the lock portion 382 is located below the locked portion 68 and faces the locked portion 68 in the up-down direction. When the first connector 12 in the mated state is moved upward, the lock portion 382 is brought into abutment with the locked portion 68 so that the first connector 12 cannot be removed from the second connector 16. Thus, the locked portion 68 and the lock portion 382 are together configured to lock the mated state.

Referring to FIG. 5 together with FIG. 4, the lock mechanism 38 of the present embodiment is located between the two key portions 30 in the thickness direction. Referring to FIG. 8, the lock mechanism 38 has a fixed end 387 fixed to a lower part of the base portion 25 and a free end 386 movable in the width direction. The free end 386 is located above the fixed end 387. The support portion 384 has the free end 386 which is located above the fixed end 387 of the support portion 384. The support portion 384 is a cantilever which extends upward from the fixed end 387. The operation portion 388 is located above the lock portion 382. Referring to FIG. 16, when the operation portion 388 is pressed and moved inward in the width direction in the mated state, the lock portion 382 is moved inward in the width direction, and thereby the mated state is unlocked. The first connector 12 can be removed from the second connector 16 by moving the first connector 12 upward in an unlocked state where the mated state is unlocked.

Referring to FIG. 5, the lock mechanism 38 of the present embodiment is located at the middle of the first connector 12 in the thickness direction and has the aforementioned structure. According to the present embodiment, the mated state can be locked in a well-balanced manner, and the mated state can be smoothly unlocked. However, the present invention is not limited thereto. For example, the structure of the lock mechanism 38 can be modified as necessary. The predetermined side 24 may have the only one base portion 25 and only one of the two key portions 30. In this instance, the predetermined side 24 may have the base portion 25 provided with the lock mechanism 38 instead of a remaining one of the two key portions 30.

As shown in FIG. 3, the operation portion 388 of the present embodiment is exposed outward of the second connector 16 in the mated state. When the removing operation of the first connector 12 is performed by an operator, the operator can remove the first connector 12 from the second connector 16 by operating the operation portion 388.

Referring to FIG. 3, the lock mechanism 38 of the present embodiment is provided at only one of opposite ends the first connector 12 in the width direction. According to another instance of the existing technique in which two of the lock mechanisms 38 are provided at the opposite ends of the first connector 12 in the width direction, respectively, the operator of the mating operation might cease the mating operation when only one of the lock mechanisms 38 is locked. Moreover, according to another instance in which the first connector 12 is provided with only one of the lock mechanisms 38 located at the middle thereof in the width direction, the connector device 10 might have a large size (thickness). According to the present embodiment, the aforementioned problem of the existing technique about the mating operation can be solved without making the connector device 10 thicker.

However, according to an instance in which the first connector 12 has only one of the lock mechanisms 38 located at one of the opposite sides thereof (hereafter, referred to as “locked side”) in the width direction, a remaining one of the opposite sides of the first connector 12 which is not provided with the lock mechanism 38 (hereafter, referred to as “free side”) seems to be easily detached when the first connector 12 receives a force which removes the first connector 12 from the second connector 16. In other words, the thus-formed first connector 12 seems to be easily turned around the locked side. If the clearance (gap) in the receiving space 186 is reduced so that a turn of the first connector 12 is prevented, it becomes difficult to remove the first connector 12. As a result, the connector device 10 might be damaged during the removing operation.

In contrast, the connector device 10 of the present embodiment has a structure which enables an easy turn of the first connector 12 around the free side while preventing another turn of the first connector 12 around the locked side. In detail, referring to FIGS. 5 and 9, the connector device 10 has two key structures KS. Each of the key structures KS consists of one of the key portions 30 of the first connector 12 and one of the key-receiving portions 60 of the second connector 16 which is configured to receive the one of the key portions 30. Each of the key structures KS has a structure for enabling an easy turn of the first connector 12 around the free side while preventing another turn of the first connector 12 around the locked side. The two key structures KS have structures same as each other and work similarly to each other. Hereafter, explanation will be made about one of the key structures KS of the present embodiment. In detail, the explanation described below is about one of the key portions 30 and one of the key-receiving portions 60. The explanation described below is applicable to each of the key structures KS.

Referring to FIG. 6, the key portion 30 of the first connector 12 has a first inner straight 32, a first outer straight 34 and an outer intersecting portion 36. The first inner straight 32 is located on an inner side of the key portion 30 in the width direction and linearly extends along the up-down direction. The first outer straight 34 is located on an outer side of the key portion 30 in the width direction and linearly extends along the up-down direction. The outer intersecting portion 36 extends downward and inward in the width direction from a lower end of the first outer straight 34.

In the present embodiment, the first inner straight 32 is the whole of an inner edge surface of the key portion 30 in the width direction and extends straight along the up-down direction from a lower end of the key portion 30 to an upper end of the key portion 30. The first outer straight 34 is an upper part of an outer edge surface of the key portion 30 in the width direction and extends straight along the up-down direction from the upper end of the key portion 30 toward the lower end of the key portion 30. The outer intersecting portion 36 is a lower part of the outer edge surface of the key portion 30 in the width direction and extends straight downward and inward in the width direction from the lower end of the first outer straight 34 to the lower end of the key portion 30.

The first inner straight 32, the first outer straight 34 and the outer intersecting portion 36 of the present embodiment are arranged as described above. The thus arranged first inner straight 32 has a lower part which is located below the first outer straight 34. However, the aforementioned arrangement can be variously modified. For example, the first inner straight 32 may be wholly located below the first outer straight 34. Thus, the first inner straight 32 may be at least partially located below the first outer straight 34.

Referring to FIG. 11, the key-receiving portion 60 of the second connector 16 is provided with a second inner straight 62, a second outer straight 64 and an inner intersecting portion 66. The second inner straight 62 is located on an inner side of the key-receiving portion 60 in the width direction and linearly extends along the up-down direction. The second outer straight 64 is located on an outer side of the key-receiving portion 60 in the width direction and linearly extends along the up-down direction. The inner intersecting portion 66 extends upward and inward in the width direction from an upper end of the second inner straight 62.

In the present embodiment, the key-receiving portion 60 is provided with a wall surface (inner wall surface) 602 and a wall surface (outer wall surface) 604. The wall surface 602 is an inner wall surface of the key-receiving portion 60 in the width direction. The wall surface 604 is an outer wall surface of the key-receiving portion 60 in the width direction. The second inner straight 62 is a lower part of the wall surface 602 and extends straight along the up-down direction from a lower end of the key-receiving portion 60 toward an upper end of the key-receiving portion 60. The inner intersecting portion 66 is an upper part of the wall surface 602 and extends straight upward and inward in the width direction from the upper end of the second inner straight 62 to the upper end of the key-receiving portion 60. The second outer straight 64 is the whole of the wall surface 604 and extends straight along the up-down direction from the upper end of the key-receiving portion 60 to the lower end of the key-receiving portion 60.

The second inner straight 62, the second outer straight 64 and the inner intersecting portion 66 of the present embodiment are arranged as described above. The thus-arranged second outer straight 64 has an upper part which is located above the second inner straight 62. However, the aforementioned arrangement can be variously modified. For example, the second outer straight 64 may be wholly located above the second inner straight 62. Thus, the second outer straight 64 may be at least partially located above the second inner straight 62.

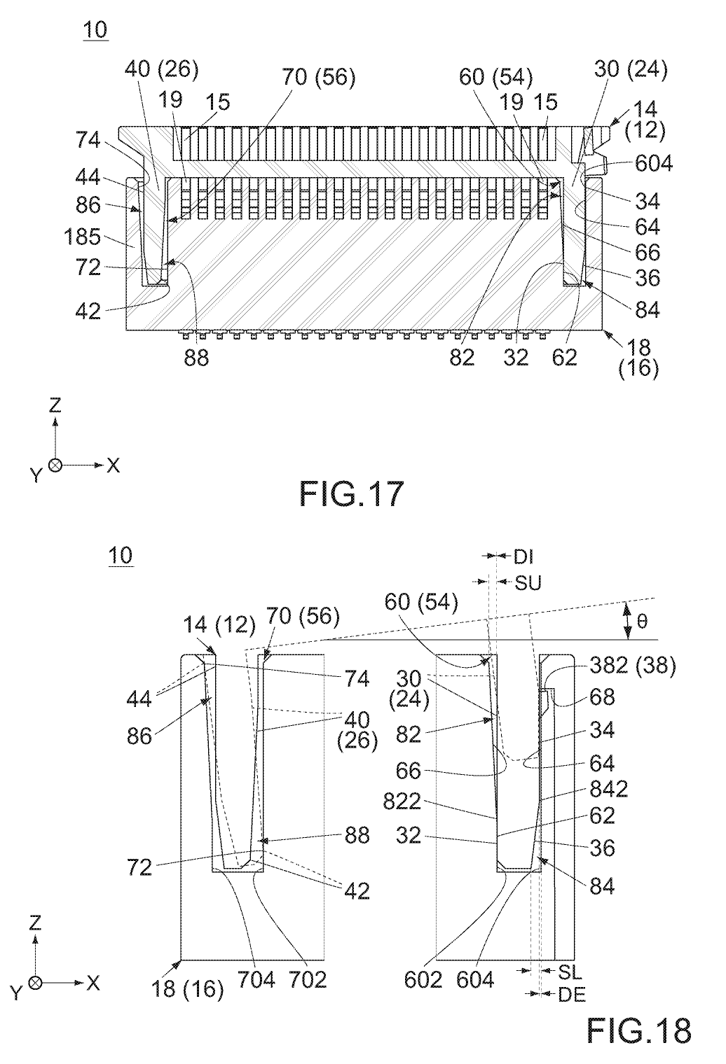

Referring to FIG. 17, during the mating operation, the second inner straight 62 and the second outer straight 64 of the second connector 16 position the first inner straight 32 and the first outer straight 34 of the first connector 12 in the width direction. The first connector 12 can be mated with the second connector 16 while being positioned in the width direction by these portions each linearly extending vertically.

Referring to FIG. 18 together with FIG. 17, in the mated state, the first inner straight 32 of the first connector 12 and the second inner straight 62 of the second connector 16 are in contact with each other in the width direction. In other words, a distance DI between the first inner straight 32 and the second inner straight 62 in the width direction is zero. In the mated state, the first outer straight 34 of the first connector 12 and the second outer straight 64 of the second connector 16 face each other with a slight distance DE formed therebetween in the width direction.

The first inner straight 32, the second inner straight 62, the first outer straight 34 and the second outer straight 64 of the present embodiment are arranged in the mated state as described above. However, the present invention is not limited thereto. For example, in the mated state, the first inner straight 32 and the second inner straight 62 may face each other with a slight distance DI formed therebetween, and the first outer straight 34 and the second outer straight 64 may be in contact with each other. Thus, in the mated state, the first inner straight 32 of the first connector 12 and the second inner straight 62 of the second connector 16 may be in contact with each other or may face each other in the width direction, and the first outer straight 34 of the first connector 12 and the second outer straight 64 of the second connector 16 may be in contact with each other or may face each other in the width direction.

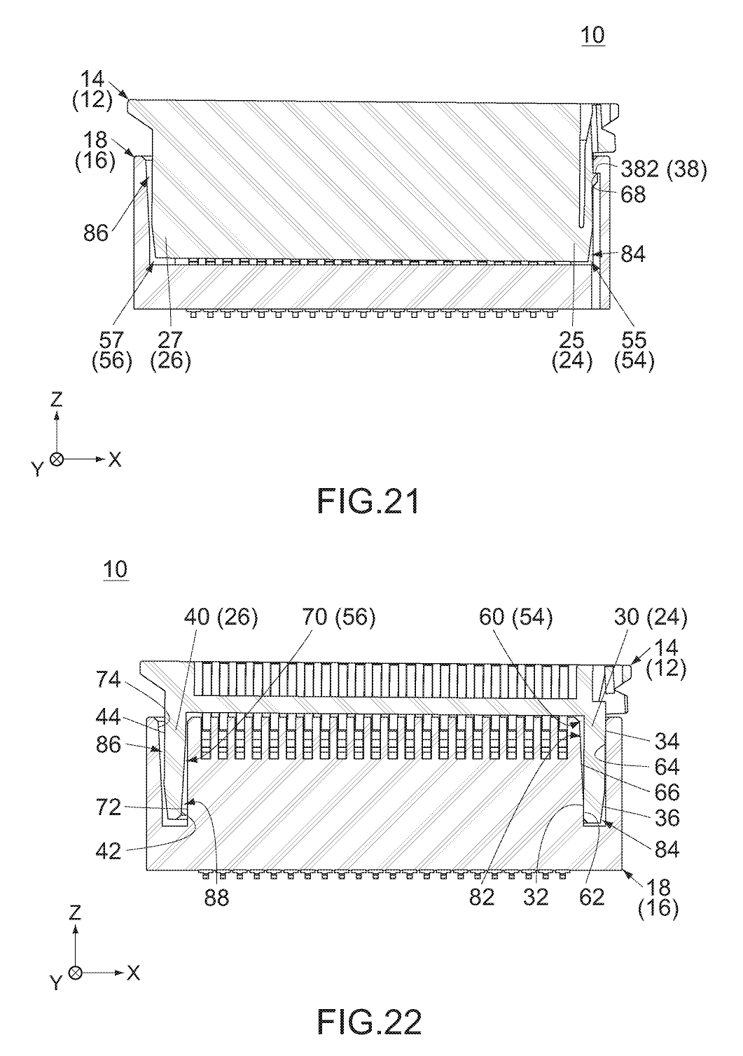

Referring to FIG. 21, when the first connector 12 in the mated state is attempted to be turned around the locked side, the mated state cannot be unlocked. Moreover, referring to FIG. 22, when the first connector 12 in the mated state is attempted to be turned around the locked side, the first inner straight 32 and the second inner straight 62 are pressed against each other, and the first outer straight 34 and the second outer straight 64 are pressed against each other. As a result, the turn of the first connector 12 around the locked side is prevented.

Referring to FIGS. 17 and 18, in the mated state, the key-receiving portion 60 is formed with an upper space 82 and a lower space 84 located therein.

The upper space 82 of the present embodiment is located above the second inner straight 62 and is located between an upper part of the first inner straight 32 and the inner intersecting portion 66 in the width direction. The upper space 82 widens upward. However, the present invention is not limited thereto. For example, in an instance in which the first inner straight 32 extends from the lower end of the key portion 30 to the upper end of the second inner straight 62, the upper space 82 may be located above the first inner straight 32 and the second inner straight 62. Thus, the upper space 82 may be located inward of the key portion 30 in the width direction and may be located above at least one of the first inner straight 32 and the second inner straight 62.

The upper space 82 has a size SU in the width direction which is larger than the distance DI between the first inner straight 32 and the second inner straight 62. The size SU of the present embodiment is the maximum size of the upper space 82 in the width direction and a width of the upper end of the upper space 82. However, the present invention is not limited thereto. For example, the size SU may be constant regardless of the position of the upper space 82 in the up-down direction, provided that the size SU is larger than the distance DI.

The lower space 84 of the present embodiment is located below the first outer straight 34 and is located between a lower part of the second outer straight 64 and the outer intersecting portion 36 in the width direction. The lower space 84 widens downward. However, the present invention is not limited thereto. For example, in an instance in which the second outer straight 64 extends from the upper end of the key-receiving portion 60 to the lower end of the first outer straight 34, the lower space 84 may be located below the first outer straight 34 and the second outer straight 64. Thus, the lower space 84 may be located outward of the key portion 30 in the width direction and may be located below at least one of the first outer straight 34 and the second outer straight 64.

The lower space 84 has a size SL in the width direction which is larger than the distance DE between the first outer straight 34 and the second outer straight 64. The size SL of the present embodiment is the maximum size of the lower space 84 in the width direction and a width of a lower end of the lower space 84. However, the present invention is not limited thereto. For example, the size SL may be constant regardless of the position of the lower space 84 in the up-down direction, provided that the size SL is larger than the distance DE.

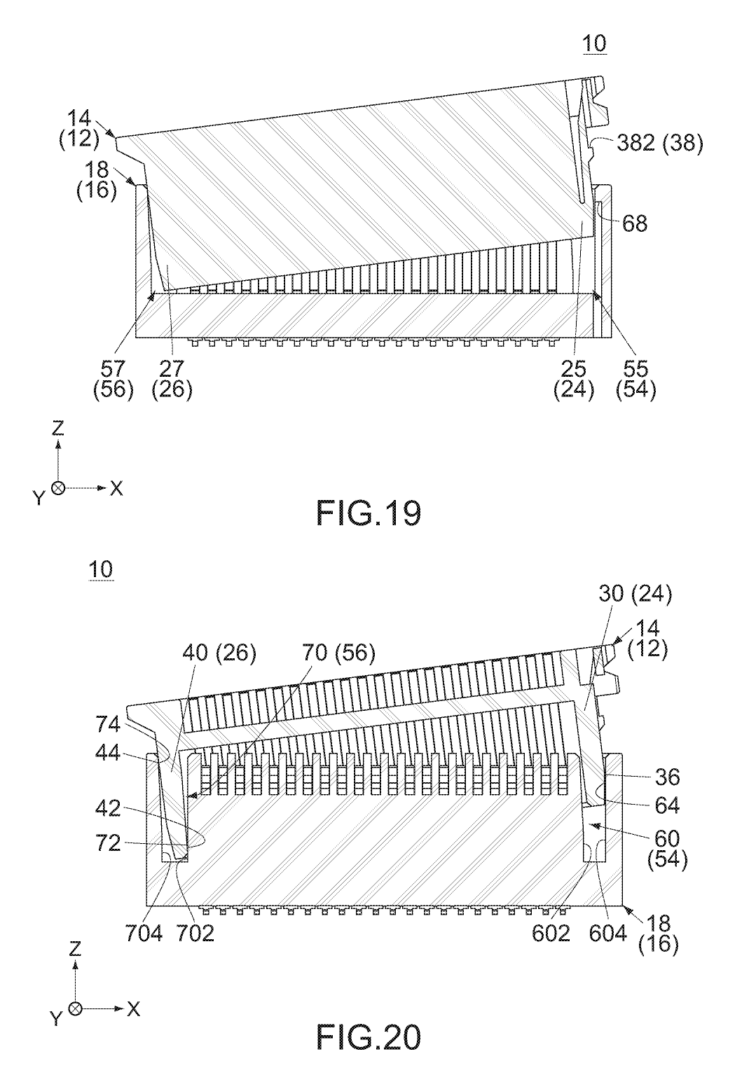

Referring to FIGS. 19 and 20 together with FIG. 18, the turn of the first connector 12 around the free side is allowed in the unlocked state because the upper space 82 and the lower space 84 are formed as described above. In detail, when the locked side of the first connector 12 is pulled up in the unlocked state, the first connector 12 can be turned so that each of the upper space 82 and the lower space 84 is reduced. The first connector 12 in the unlocked state can be removed from the second connector 16 by moving the first connector 12 straight upward or turning the first connector 12 around the free side. When the first connector 12 is turned around the free side, the thus-turned first connector 12 takes the state shown in FIGS. 19 and 20. The first connector 12 illustrated in FIGS. 19 and 20 can be removed from the second connector 16 merely by pulling the locked side upward so that the first connector 12 is moved upward.

According to the present embodiment, the operator of the removing operation of the first connector 12 can remove the first connector 12 from the second connector 16 while turning the first connector 12 merely by the removing operation described below. Firstly, the lock mechanism 38 of the first connector 12 is operated to be unlocked with one hand. Then, the locked side of the first connector 12 is pulled up with one hand so that the key portions 30 are moved upward. Hereafter, this removing operation is referred to as “turning removal”. According to the present embodiment, the operator can remove the first connector 12 by the turning removal with a small force. Moreover, according to the present embodiment, the first connector 12 in the unlocked state can be removed from the second connector 16 not only by the turning removal but also by moving the first connector 12 straight upward from the second connector 16. As can be seen from the explanation described above, the present embodiment provides the connector device 10 having a structure which is suitable to provide the lock mechanism 38 only at one of the opposite ends of the connector device 10 in the width direction.

Referring to FIG. 16 together with FIG. 17, in the mated state, a lower part of the base-receiving portion 55 of the present embodiment is formed with a wide space which includes the lower space 84 in the vertical plane (XZ-plane). Accordingly, the base portion 25 received in the base-receiving portion 55 does not make the turning removal difficult. However, the present invention is not limited thereto. The structure of the base-receiving portion 55 is not specifically limited, provided that the base portion 25 in the mated state is received in the base-receiving portion 55 so that the turning removal is not made difficult.

Referring to FIG. 18, in an instance in which each of the distance DI and the distance DE is long, various problems such that the first connector 12 cannot be accurately positioned are generated. Accordingly, each of the distance DI and the distance DE is preferred to be as short as possible.

According to the present embodiment, the upper space 82 and the lower space 84 are located at positions, respectively, which are partially same as each other in the up-down direction. In detail, the upper space 82 has a lower end 822 which is located below an upper end 842 of the lower space 84. According to this arrangement, the operator can easily remove the first connector 12 by the turning removal even in an instance in which each of the distance DI and the distance DE is zero or extremely close to zero. However, the present invention is not limited thereto. For example, the lower end 822 of the upper space 82 may be located at the same position as the upper end 842 of the lower space 84 in the up-down direction. In an instance in which each of the distance DI and the distance DE is sufficiently long, the lower end 822 of the upper space 82 may be located above the upper end 842 of the lower space 84.

Referring to FIG. 17, the lower space 84 of the key-receiving portion 60 of the present embodiment is located between the outer intersecting portion 36 of the first connector 12 and the wall surface 604 of the key-receiving portion 60 of the second connector 16 in the width direction. The lower space 84 can be formed by cutting off a part of a lower part of the key portion 30 which is located at an outer side of the key portion 30 in the width direction. According to this structure, the first connector 12 can be easily removed by the turning removal.

The upper space 82 of the key-receiving portion 60 of the present embodiment is located between the inner intersecting portion 66 and the key portion 30 of the first connector 12 in the width direction. The upper space 82 can be formed by cutting off a part of the upper part of the wall surface 602 of the key-receiving portion 60. According to this structure, the first connector 12 can be further easily removed by the turning removal.

Each of the lower space 84 and the upper space 82 of the present embodiment has the aforementioned structure. However, the present invention is not limited thereto. As described later, the structure of each of the lower space 84 and the upper space 82 can be variously modified.

Referring to FIGS. 5 and 9, as previously described, the first connector 12 of the present embodiment is provided with the two key portions 30, and the second connector 16 of the present embodiment is formed with the two key-receiving portions 60 which are configured to receive the two key portions 30, respectively. The two key portions 30 have a mirror-symmetric structure with respect to the vertical plane (XZ-plane), and the two key-receiving portions 60 have a mirror-symmetric structure with respect to the vertical plan. According to this structure, the first connector 12 can be smoothly removed by the turning removal. However, the present invention is not limited thereto. For example, the first connector 12 may be provided with only one of the key portions 30, and the second connector 16 may be formed with only one of the key-receiving portions 60.

The connector device 10 of the present embodiment further has a structure which controls the turn of the first connector 12 around the free side. More specifically, the additional side 26 of the first connector 12 and the additional accommodation portion 56 of the second connector 16 which corresponds to the additional side 26 have a structure which controls the turn around the free side of the first connector 12. Hereafter, explanation will be made about the additional side 26 and the additional accommodation portion 56 of the present embodiment.

Referring to FIG. 5, the additional side 26 of the first connector 12 of the present embodiment has an additional base portion 27 and two additional key portions 40.

Referring to FIG. 5 together with FIGS. 4 and 6, the additional base portion 27 is located at the same position as the main portion 22 in the thickness direction. The two additional key portions 40 are located on opposite sides of the additional base portion 27 in the thickness direction, respectively, and extend in parallel to each other along the up-down direction. Thus, each of the additional key portions 40 extends in the up-down direction and protrudes from the main portion 22 in the thickness direction. The additional key portions 40 of the present embodiment protrude from opposite sides of the main portion 22 In the thickness direction. In detail, the two additional key portions 40 protrude from an end of the main portion 22 in the width direction so as to be away from each other in the thickness direction. Each of the additional key portions 40 does not overlap with the main portion 22 in the thickness direction. Moreover, the two additional key portions 40 have a mirror-symmetric structure with respect to the vertical plane (XZ-plane) and work similarly to each other.

The additional side 26 of the present embodiment has the aforementioned structure. However, the present invention is not limited thereto. For example, the additional side 26 may further have another portion in addition to the aforementioned portions. The additional base portion 27 may be provided as necessary. In an instance in which the additional base portion 27 is not provided, each of the additional key portions 40 may partially overlap with the main portion 22 in the thickness direction. The additional side 26 may have only one of the additional key portions 40 which protrudes from the main portion 22 in the thickness direction.

Referring to FIG. 9, the additional accommodation portion 56 of the second connector 16 of the present embodiment includes an additional base-receiving portion 57 and two additional key-receiving portions 70. Referring to FIG. 16, the additional base-receiving portion 57 is configured to receive the additional base portion 27 of the first connector 12. Referring to FIGS. 14 and 15, the additional key-receiving portions 70 are configured to receive the additional key portions 40 of the first connector 12, respectively.

Referring to FIG. 9 together with FIG. 11, the additional base-receiving portion 57 is located at the same position as the main accommodation portion 52 in the thickness direction. The two additional key-receiving portions 70 are located on opposite sides of the additional base-receiving portion 57 in the thickness direction, respectively, and extend in parallel to each other along the up-down direction. Thus, each of the additional key-receiving portions 70 extends in the up-down direction and protrudes from the main accommodation portion 52 in the thickness direction. The additional key-receiving portions 70 of the present embodiment protrude from opposite sides of the main accommodation portion 52 in the thickness direction. In detail, the two additional key-receiving portions 70 protrude from an end of the main accommodation portion 52 in the width direction so as to be away from each other in the thickness direction. Each of the additional key-receiving portions 70 does not overlap with the main accommodation portion 52 in the thickness direction. Moreover, the two additional key-receiving portions 70 have a mirror-symmetric structure with respect to the vertical plane (XZ-plane) and work similarly to each other.

The additional accommodation portion 56 of the present embodiment has the aforementioned structure. However, the present invention is not limited thereto. For example, the additional accommodation portion 56 may further include another space in addition to the aforementioned spaces. In an instance in which the first connector 12 (see FIG. 5) does not have the additional key portions 40 (see FIG. 5), the additional base-receiving portion 57 does not need to be provided. In an instance in which the additional base-receiving portion 57 is not provided, each of the additional key-receiving portions 70 may partially overlap with the main accommodation portion 52 in the thickness direction. The additional accommodation portion 56 may include only one of the additional key-receiving portions 70 which protrudes from the main accommodation portion 52 in the thickness direction.

Referring to FIGS. 5 and 9, the connector device 10 of the present embodiment has two additional key structures AS. Each of the additional key structures AS consists of one of the additional key portions 40 of the first connector 12 and one of the additional key-receiving portions 70 of the second connector 16 which is configured to receive the one of the additional key portions 40. Each of the additional key structures AS has a structure for controlling the turn of the first connector 12 around the free side. The two additional key structures AS have structures same as each other and work similarly to each other. Hereafter, explanation will be made about one of the additional key structures AS of the present embodiment. In detail, the explanation described below is about one of the additional key portions 40 and one of the additional key-receiving portions 70. The explanation described below is applicable to each of the additional key structures AS.

Referring to FIG. 6, the additional key portion 40 of the first connector 12 has an inner abutment portion 42 and an outer abutment portion 44. The inner abutment portion 42 is located on an inner side of the additional key portion 40 in the width direction. The outer abutment portion 44 is located on an outer side of the additional key portion 40 in the width direction. The inner abutment portion 42 is located below the outer abutment portion 44. In detail, the inner abutment portion 42 of the present embodiment is a part of an inner edge surface of the additional key portion 40 in the width direction and is located in the vicinity of a lower end of the additional key portion 40. The outer abutment portion 44 of the present embodiment is a part of an outer edge surface of the additional key portion 40 in the width direction and is located in the vicinity of an upper end of the additional key portion 40.

Referring to FIG. 11 together with FIG. 6, the additional key-receiving portion 70 of the second connector 16 is provided with an inner stopper 72 and an outer stopper 74 which correspond to the inner abutment portion 42 and the outer abutment portion 44 of the first connector 12, respectively. In detail, the additional key-receiving portion 70 of the present embodiment is provided with a wall surface (inner wall surface) 702 and a wall surface (outer wall surface) 704. The wall surface 702 is an inner wall surface of the additional key-receiving portion 70 in the width direction. The wall surface 704 is an outer wall surface of the additional key-receiving portion 70 in the width direction. The inner stopper 72 is a part of the wall surface 702 and is located in the vicinity of a lower end of the additional key-receiving portion 70. The outer stopper 74 is a part of the wall surface 704 and is located in the vicinity of an upper end of the additional key-receiving portion 70.

Referring to FIG. 18 together with FIGS. 19 and 20, when the first connector 12 in the unlocked state is turned around the free side by a predetermined angle θ, the inner abutment portion 42 and the outer abutment portion 44 of the first connector 12 are brought into abutment with the inner stopper 72 and the outer stopper 74, respectively, and thereby the turn of the first connector 12 is stopped. If the turn beyond the predetermined angle θ is allowed, each of the first terminals 15 of the first connector 12 might be brought into contact with the second terminal 19 which is adjacent to the corresponding second terminal 19 of the second connector 16. According to the present embodiment, the aforementioned unintended contact can be prevented because the additional key portion 40 and the additional key-receiving portion 70 are provided. However, the present invention is not limited thereto. For example, the additional key portion 40 and the additional key-receiving portion 70 may be provided as necessary.

According to the present embodiment, when the first connector 12 is turned by the predetermined angle θ, the inner abutment portion 42 is brought into abutment with the inner stopper 72, and the outer abutment portion 44 is brought into abutment with the outer stopper 74. According to this structure, the turn of the first connector 12 beyond the predetermined angle θ can be reliably prevented. However, the present invention is not limited thereto. For example, when the first connector 12 is turned by the predetermined angle θ, only the inner abutment portion 42 may be brought into abutment with the inner stopper 72, or only the outer abutment portion 44 may be brought into abutment with the outer stopper 74.

Summarizing the explanation described above, according to the present embodiment, when the key portion 30 of the first connector 12 in the mated state is moved upward so that the first connector 12 is turned by the predetermined angle θ relative to the second connector 16, at least one of the inner abutment portion 42 and the outer abutment portion 44 is brought into abutment with a corresponding one of the inner stopper 72 and the outer stopper 74 and thereby a turn beyond the predetermined angle θ is prevented.

The turn of the first connector 12 around the free side may be stopped by an abutment of the key portion 30 with the wall surface 602 or the wall surface 604. In this instance, the inner abutment portion 42, the inner stopper 72, the outer abutment portion 44 and the outer stopper 74 do not need to be provided. However, according to an instance in which these portions are not provided, the turn of the first connector 12 around the free side might not be completely stopped even after the key portion 30 is brought into abutment with the wall surface 602 or the wall surface 604. In detail, the first connector 12 might be moved upward so as to slide on the wall surface 602 or the wall surface 604 while being turned. Accordingly, it is preferable to stop the turn of the first connector 12 around the free side by an abutment at the free side which is the center of the turn. Thus, the present embodiment is preferable if there is no special reason.

Referring to FIGS. 17 and 18, in the mated state, the additional key-receiving portion 70 is formed with an additional upper space 86 and an additional lower space 88 located therein. The additional upper space 86 is located outward of the additional key portion 40 in the width direction. The additional lower space 88 is located inward of the additional key portion 40 in the width direction. The additional upper space 86 of the present embodiment is located at an upper part of the additional key-receiving portion 70. The additional lower space 88 of the present embodiment is located at a lower part of the additional key-receiving portion 70. The additional lower space 88 is at least partially located below the additional upper space 86.

Because the additional upper space 86 and the additional lower space 88 are formed as described above, the first connector 12 can be relatively largely turned around the free side, and thereby the turning removal can be easily performed. More specifically, the first connector 12 in the unlocked state can be turned around the free side by the predetermined angle θ. Moreover, in the mated state, an upper part of the additional base-receiving portion 57 of the present embodiment is formed with a space which overlaps with the additional upper space 86 in the vertical plane (XZ-plane). Accordingly, the additional base portion 27 received in the additional base-receiving portion 57 does not make the turning removal difficult.

However, the present invention is not limited thereto. For example, the additional upper space 86 and the additional lower space 88 may be formed as necessary and may be formed in a required size. In an instance in which the additional side 26 is not provided, the additional upper space 86 and the additional lower space 88 do not need to be formed. The additional lower space 88 may be wholly located below the additional upper space 86. Moreover, the first connector 12 can be removed from the second connector 16 without being turned or after turning the first connector 12 by an angle smaller than the predetermined angle θ. Accordingly, the structure of the base-receiving portion 55 is not specifically limited.

Hereafter, explanation will be made about six modifications of the connector device 10 of the present embodiment.

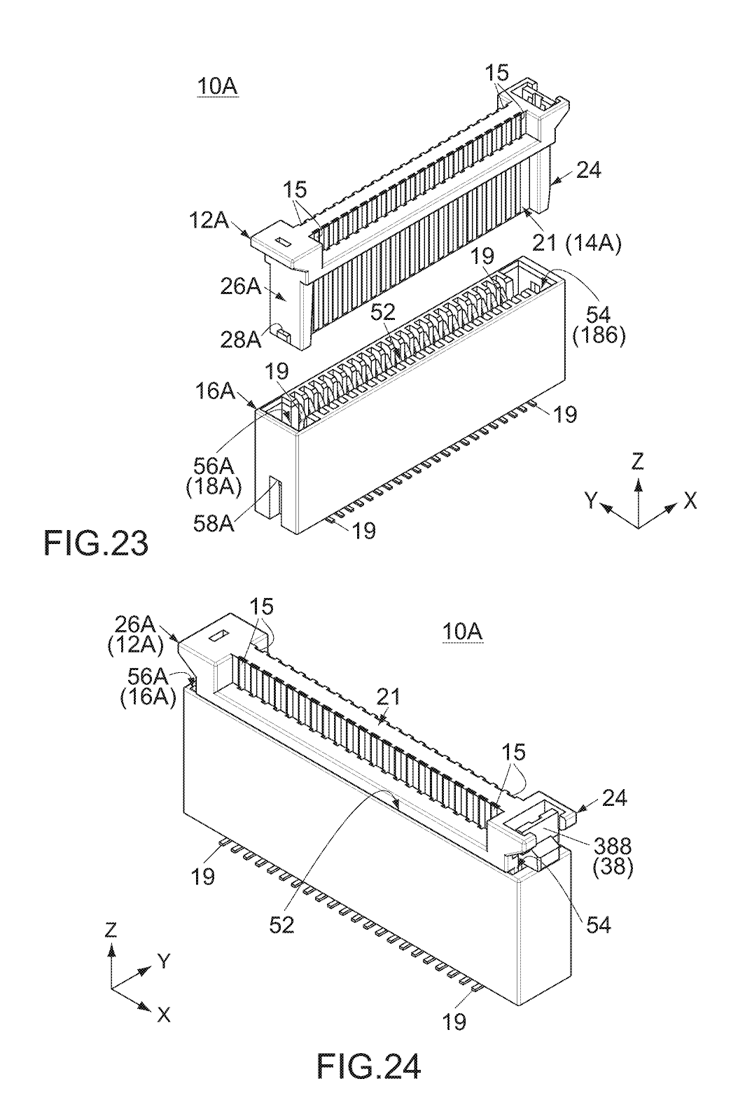

As shown in FIGS. 23, 24 and 32, a connector device 10A according to a first modification comprises a first connector 12A and a second connector 16A. The first connector 12A is mateable with the second connector 16A, which is located below the first connector 12A in the up-down direction, along the up-down direction. The first connector 12A mated with the second connector 16A is removable upward. The connector device 10A illustrated in FIG. 23 is in a separated state where the first connector 12A and the second connector 16A are separated from each other. The connector device 10A illustrated in FIGS. 24 and 32 is in a mated state where the first connector 12A and the second connector 16A are mated with each other.

Comparing FIG. 23 with FIG. 2, the first connector 12A comprises a first holding member 14A different from the first holding member 14 of the first connector 12 and the first terminals 15 same as those of the first connector 12. The first holding member 14A has an additional side 26A which is different from the additional side 26 of the first holding member 14. The additional side 26A has a lower end whose outer shape in the width direction is different from an outer shape of a lower end of the additional side 26 in the width direction.

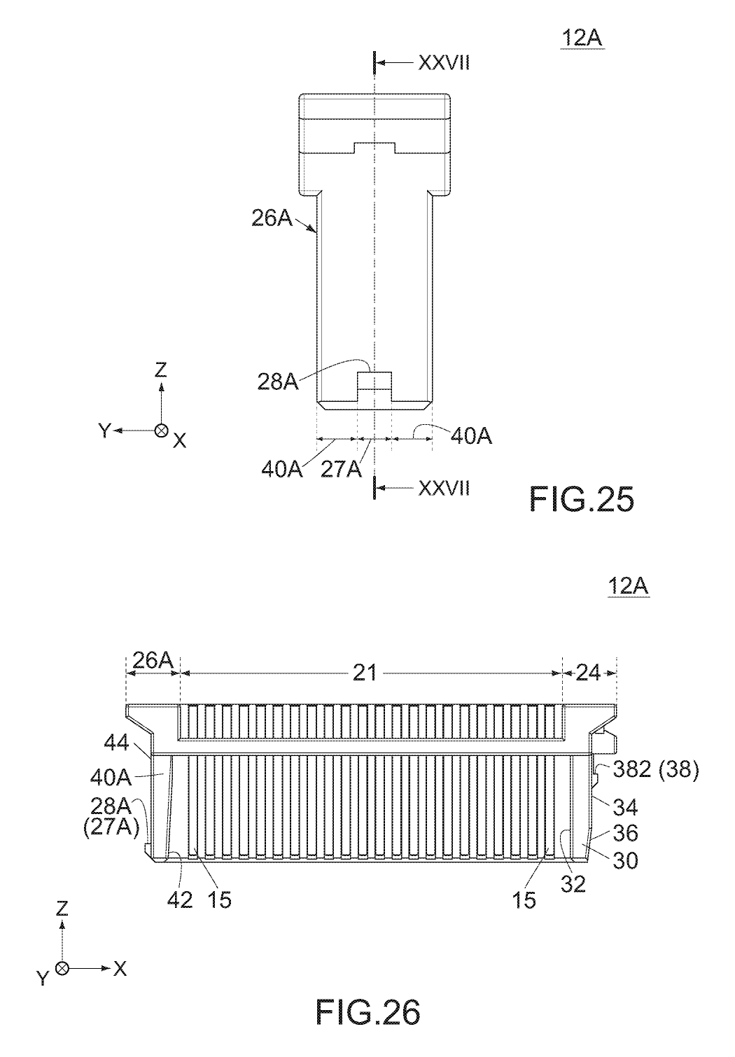

More specifically, referring to FIG. 25, the additional side 26A has an additional base portion 27A and two additional key portions 40A. The additional base portion 27A is provided with a projecting portion 28A. Thus, the additional side 26A is provided with the projecting portion 28A.

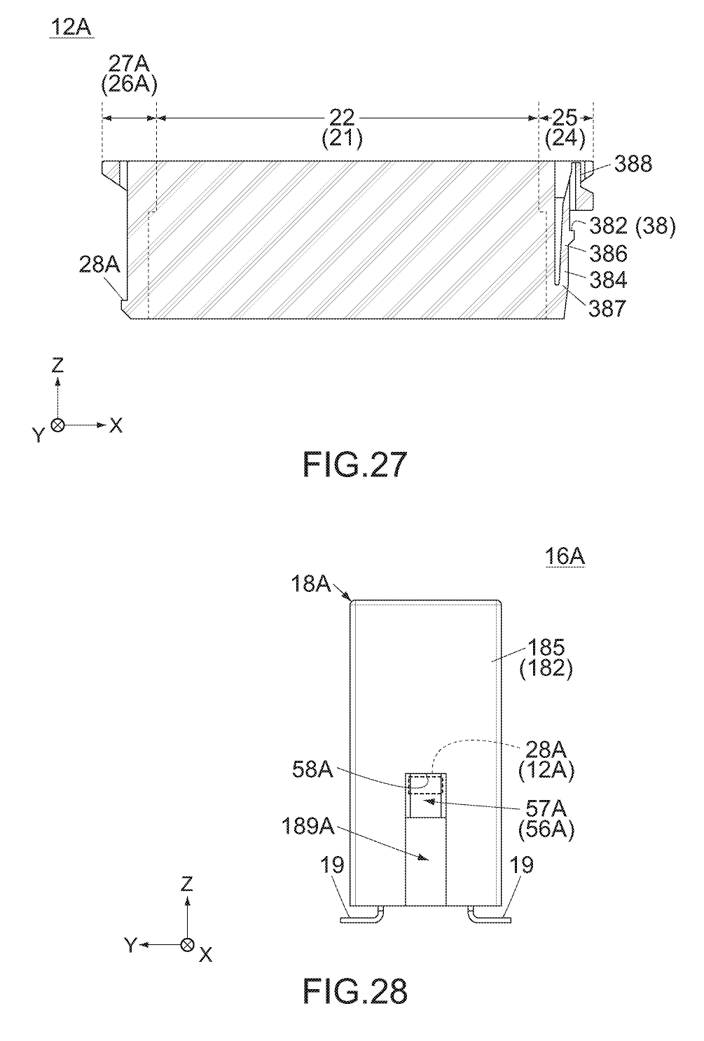

Referring to FIGS. 25 to 27, the projecting portion 28A is located on a lower end of the additional base portion 27A and projects outward in the width direction from an outer edge surface of the additional base portion 27A in the width direction. Thus, the projecting portion 28A projects outward in the width direction from the additional side 26A. The projecting portion 28A is fixed to the first connector 12A so as to be unmovable relative to the first connector 12A. The projecting portion 28A has an upper surface which is a flat surface extending in parallel to the horizontal plane. Each of the additional key portions 40A has a part which is adjacent to the projecting portion 28A in the thickness direction and is a flat surface perpendicular to the width direction. The first connector 12A has a structure same as that of the first connector 12 (see FIG. 2) except for the aforementioned differences and works similarly to the first connector 12.

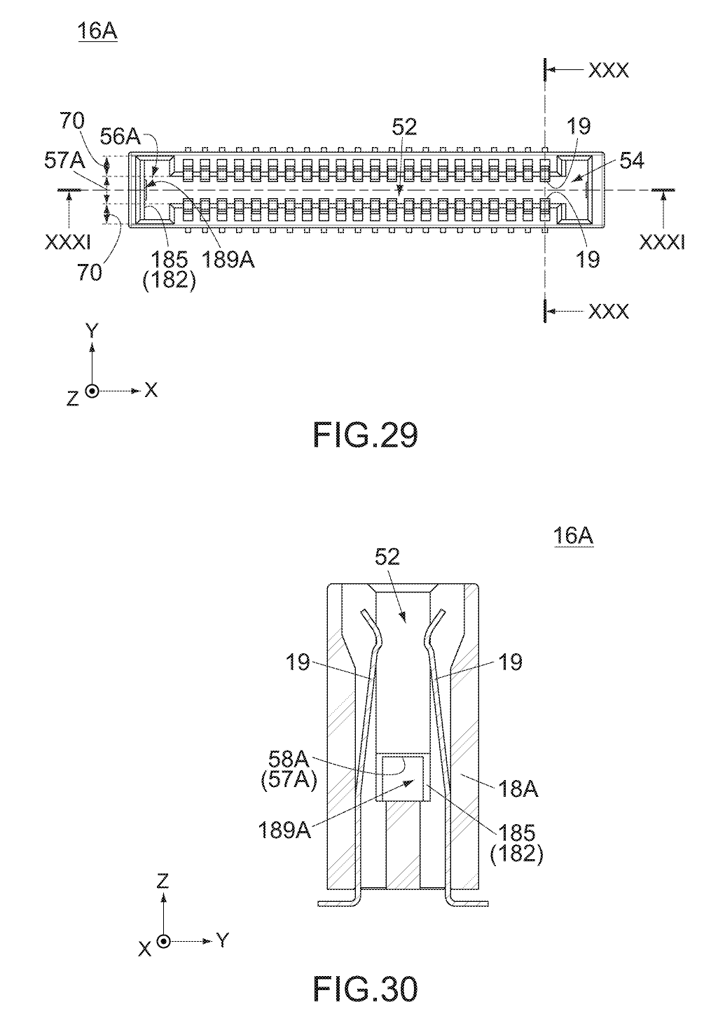

Comparing FIG. 23 with FIG. 2, the second connector 16A comprises a second holding member 18A different from the second holding member 18 of the second connector 16 and the second terminals 19 same as those of the second connector 16. The second holding member 18A has an additional accommodation portion 56A which is different from the additional accommodation portion 56 of the second holding member 18. More specifically, referring to FIG. 29, the additional accommodation portion 56A includes an additional base-receiving portion 57A and the two additional key-receiving portions 70. The additional base-receiving portion 57A is provided with a facing portion 58A. Thus, the additional accommodation portion 56A is provided with the facing portion 58A. Comparing FIG. 23 with FIG. 2, the thus-formed additional accommodation portion 56A has a lower end whose outer shape in the width direction is different from an outer shape of a lower end of the additional accommodation portion 56 in the width direction.

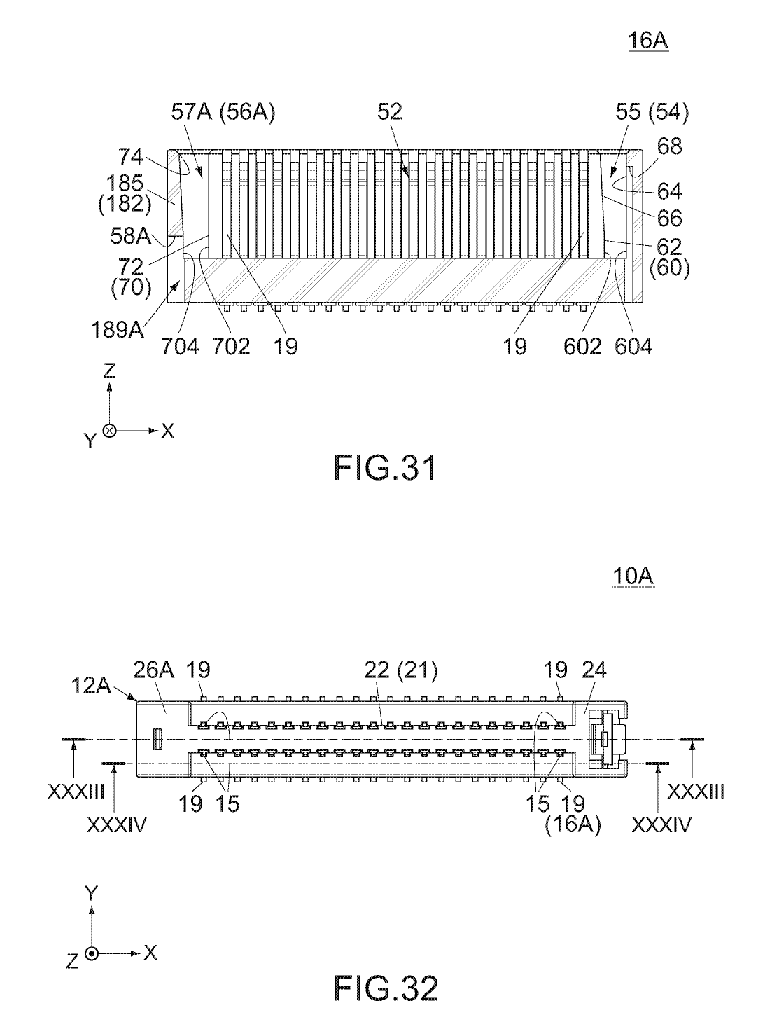

Referring to FIGS. 28-31, the end wall 185 of the second connector 16A is located outward of the additional accommodation portion 56A in the width direction. The end wall 185 has a lower part which is formed with a cut 189A. The cut 189A passes through the end wall 185 in the width direction. The facing portion 58A of the present embodiment is an upper surface of the cut 189A and is a flat surface which extends in parallel to the horizontal plane. The facing portion 58A is fixed to the second connector 16A so as to be unmovable relative to the second connector 16A.

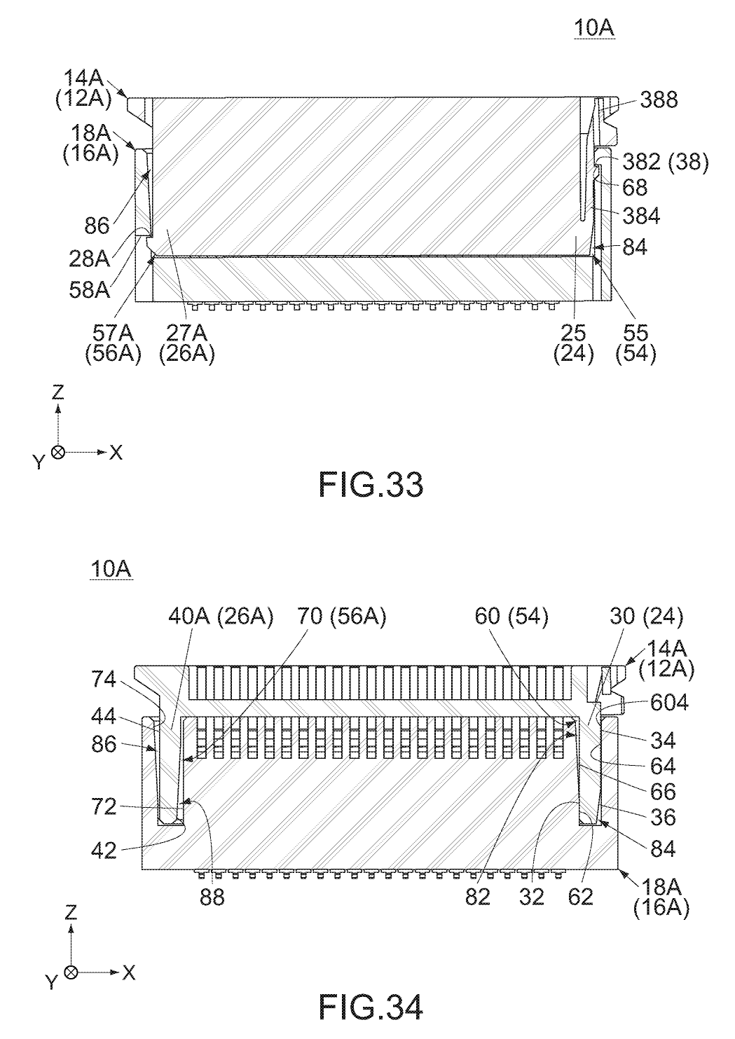

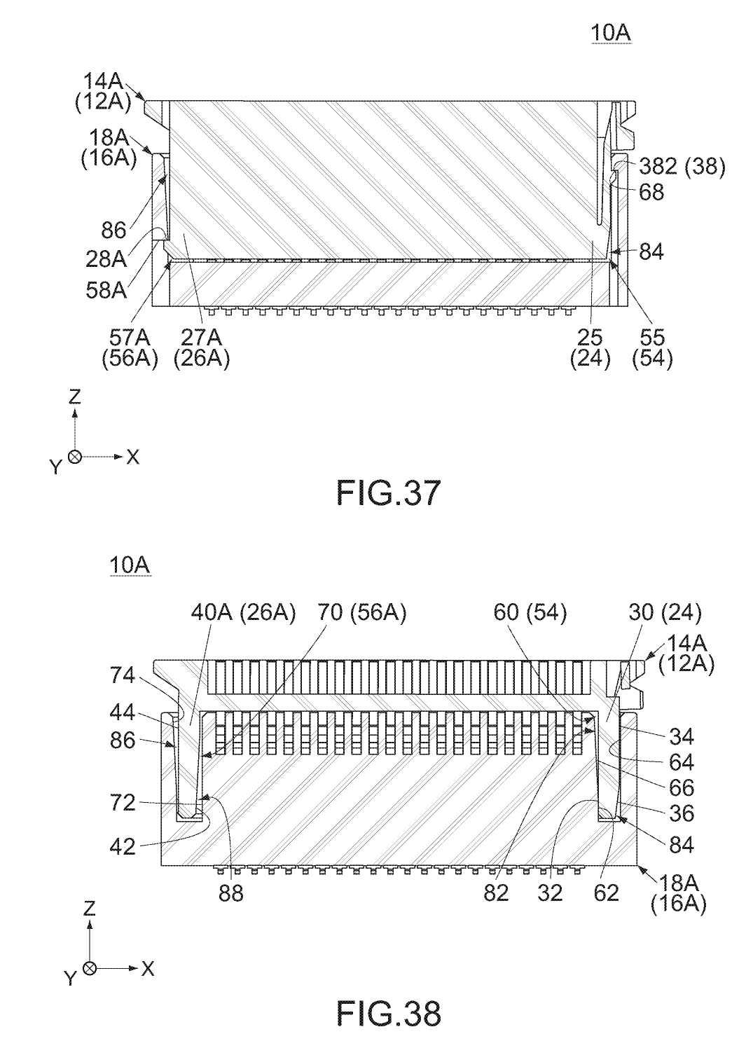

Referring to FIGS. 33 and 34, in the mated state, the facing portion 58A is located above the projecting portion 28A and faces the projecting portion 28A in the up-down direction. Referring to FIGS. 37 and 38, when the first connector 12A is turned around the locked side, the upper surface of the projecting portion 28A is brought into abutment with the facing portion 58A, and thereby a turn of the first connector 12A is stopped. According to the present embodiment, the turn of the first connector 12A around the locked side can be further reliably prevented.

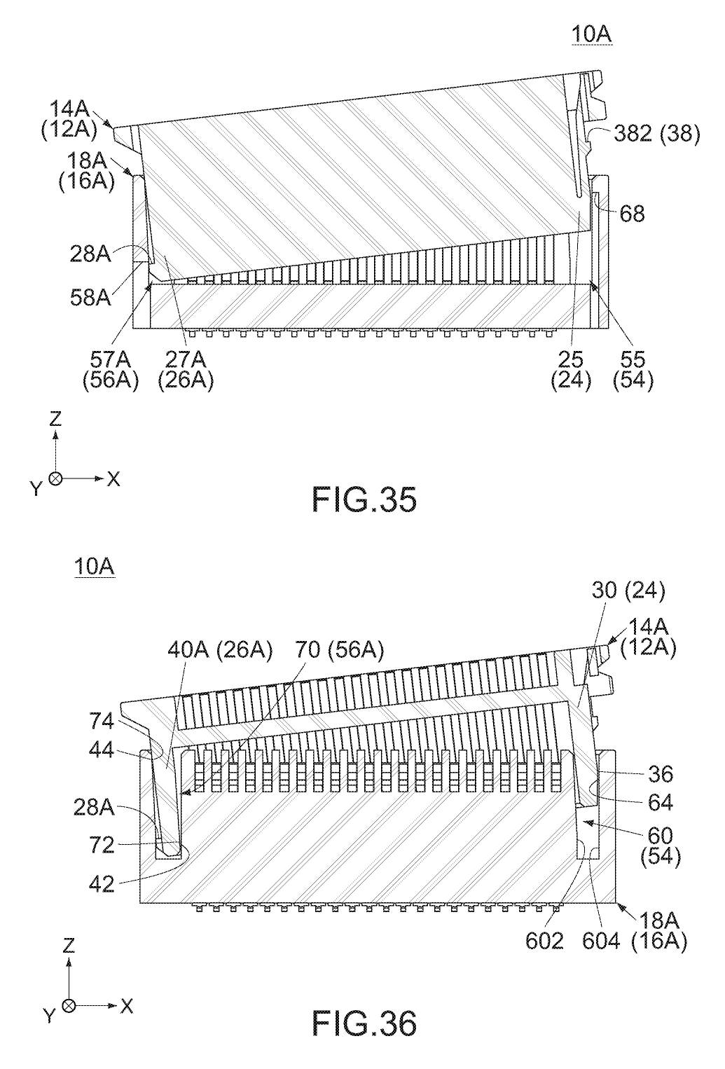

Referring to FIGS. 35 and 36, the first connector 12A can be turned around the free side although having the projecting portion 28A. When the key portions 30 of the first connector 12A in the mated state are moved upward so that the first connector 12A is turned by the predetermined angle θ (see FIG. 17) relative to the second connector 16A, the projecting portion 28A is moved to a position which is different from a position of the facing portion 58A in the width direction and thereby does not face the facing portion 58A in the up-down direction. The first connector 12A in the state shown in FIGS. 35 and 36 can be removed from the second connector 16A merely by pulling the locked side upward. Thus, the operator can remove the first connector 12A by the turning removal. The first connector 12A of the present modification can be removed from the second connector 16A by the turning removal but cannot be removed from the second connector 16A by moving the first connector 12A straight upward from the second connector 16A.

Referring to FIG. 23, the first connector 12A having the projecting portion 28A can be mated with the second connector 16A as described below. Firstly, the first connector 12A is inclined by the predetermined angle θ (see FIG. 17) relative to the second connector 16A. Then, the thus-inclined first connector 12A is inserted into the receiving space 186 of the second connector 16A. The thus-inserted first connector 12A takes the state shown in FIGS. 35 and 36. Then, the first connector 12A is turned so that the first connector 12A extends along the width direction. Meanwhile, the first connector 12A is mated with the second connector 16A and takes the state shown in FIGS. 33 and 34.

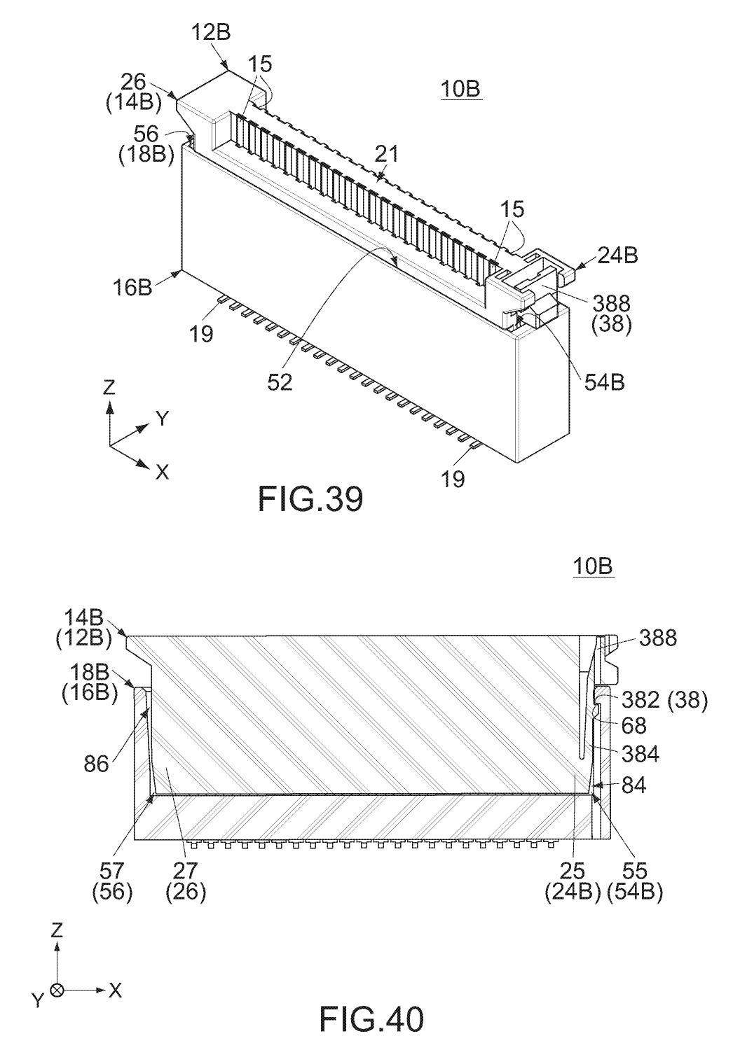

As shown in FIG. 39, a connector device 10B according to a second modification comprises a first connector 12B and a second connector 16B. The first connector 12B is mateable with the second connector 16B, which is located below the first connector 12B in the up-down direction, along the up-down direction. The first connector 12B mated with the second connector 16B is removable upward. The connector device 10B illustrated in FIG. 39 is in a mated state where the first connector 12B and the second connector 16B are mated with each other.

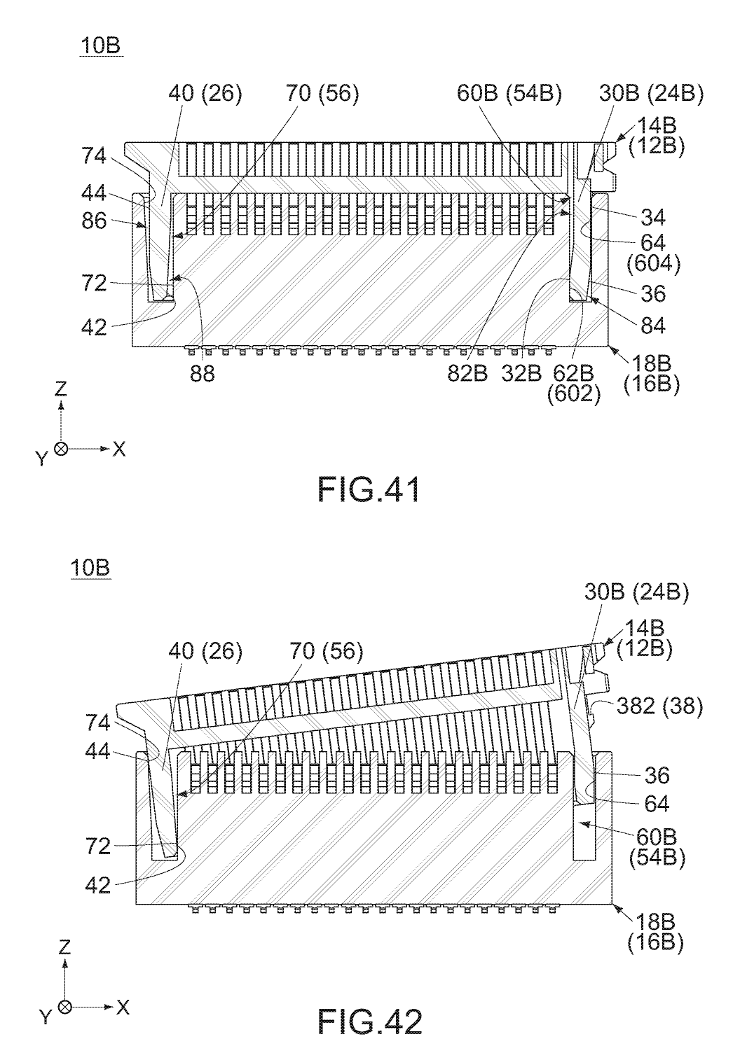

Comparing FIG. 39 with FIG. 3, the first connector 12B comprises a first holding member 14B different from the first holding member 14 of the first connector 12 and the first terminals 15 same as those of the first connector 12. The first holding member 14B has a predetermined side 24B which is different from the predetermined side 24 of the first holding member 14. Referring to FIGS. 40 and 41 together with FIGS. 5, 16 and 17, the predetermined side 24B has the base portion 25 same as that of the predetermined side 24 and two key portions 30B which are different from the two key portions 30 of the predetermined side 24, respectively. The two key portions 30B have a mirror-symmetric structure with respect to the vertical plane (XZ-plane) and work similarly to each other. As described above, the first connector 12B has the key portions 30B different from the key portions 30 of the first connector 12. The first connector 12B has a structure same as that of the first connector 12 except for this difference and works similarly to the first connector 12.

Comparing FIG. 39 with FIG. 3, the second connector 16B comprises a second holding member 18B different from the second holding member 18 of the second connector 16 and the second terminals 19 same as those of the second connector 16. The second holding member 18B is formed with a predetermined accommodation portion 54B which is different from the predetermined accommodation portion 54 of the second holding member 18. Referring to FIGS. 40 and 41 together with FIGS. 9, 16 and 17, the predetermined accommodation portion 54B includes the base-receiving portion 55 same as that of the predetermined accommodation portion 54 and two key-receiving portions 60B which are different from the two key-receiving portions 60 of the predetermined accommodation portion 54, respectively. The two key-receiving portions 60B have a mirror-symmetric structure with respect to the vertical plane (XZ-plane) and work similarly to each other. As described above, the second connector 16B is formed with the key-receiving portions 60B different from the key-receiving portions 60 of the second connector 16. The second connector 16B has a structure same as that of the second connector 16 except for this difference and works similarly to the second connector 16.

Hereafter, explanation will be made about one of the two key portions 30B and one of the two key-receiving portions 60B which is configured to receive this key portion 30B. The explanation described below is applicable to a remaining one of the two key portions 30B and one of the two key-receiving portions 60B which is configured to receive this key portion 30B.

Referring to FIG. 41, the key portion 30B of the first connector 12B has a first inner straight 32B, the first outer straight 34 and the outer intersecting portion 36. The first inner straight 32B is located on an inner side of the key portion 30B in the width direction and linearly extends along the up-down direction. The first outer straight 34 is located on an outer side of the key portion 30B in the width direction and linearly extends along the up-down direction. The outer intersecting portion 36 extends downward and inward in the width direction from the lower end of the first outer straight 34.

Comparing FIG. 41 with FIG. 17, the first inner straight 32B is a lower part of an inner edge surface of the key portion 30B in the width direction and extends straight along the up-down direction from a lower end of the key portion 30B toward an upper end of the key portion 30B. The first inner straight 32B is shorter than the first inner straight 32 in the up-down direction. The key portion 30B has a structure same as that of the key portion 30 except for this difference and works similarly to the key portion 30.

Referring to FIG. 41, the key-receiving portion 60B of the second connector 16B is provided with a second inner straight 62B and the second outer straight 64. The second inner straight 62B is located on an inner side of the key-receiving portion 60B in the width direction and linearly extends along the up-down direction. The second outer straight 64 is located on an outer side of the key-receiving portion 60B in the width direction and linearly extends along the up-down direction.

Comparing FIG. 41 with FIG. 17, the second inner straight 62B is the whole of the wall surface 602 and extends straight along the up-down direction from a lower end of the key-receiving portion 60B to an upper end of the key-receiving portion 60B. The key-receiving portion 60B is not provided with the inner intersecting portion 66. The key-receiving portion 60B has a structure same as that of the key-receiving portion 60 except for the aforementioned differences and works similarly to the key-receiving portion 60.

Referring to FIG. 41, in the mated state, the key-receiving portion 60B is formed with an upper space 82B and the lower space 84 located therein. Comparing FIG. 41 with FIG. 17, the lower space 84 of the present modification has a structure same as that of the lower space 84 of the key-receiving portion 60. The arrangement of the upper space 82B of the present modification is different from that of the upper space 82 of the key-receiving portion 60. More specifically, the upper space 82B is located between the second inner straight 62B of the second connector 16B and the key portion 30B of the first connector 12B in the width direction. The upper space 82B can be formed by cutting off a part of an upper part of the key portion 30B which is located at an inner side of the key portion 30B in the width direction. The thus-shaped upper part of the key portion 30B is formed with a recess which is recessed outward in the width direction from an inner edge surface of the key portion 30B in the width direction.

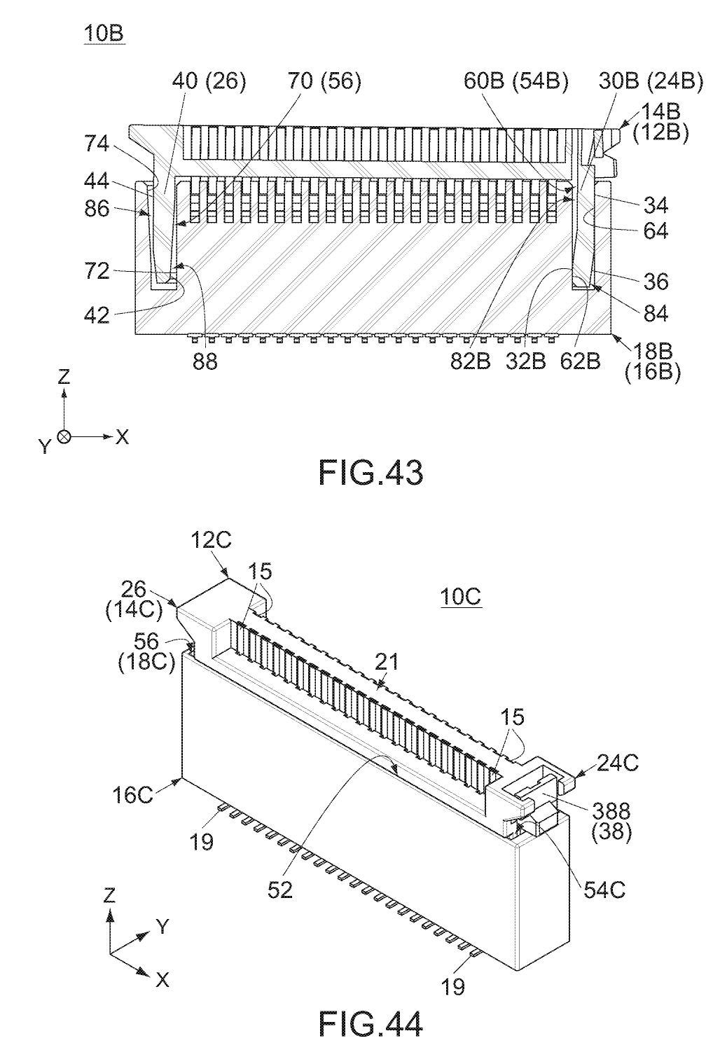

Comparing FIG. 43 with FIG. 22, according to the present modification, a turn of the first connector 12B around the locked side can be prevented similarly to the previously described embodiment. Comparing FIG. 42 with FIG. 20, the first connector 12B of the present modification can be turned around the free side similarly to the first connector 12. Accordingly, the first connector 12B can be easily removed by the turning removal.

As shown in FIG. 44, a connector device 10C according to a third modification comprises a first connector 12C and a second connector 16C. The first connector 12C is mateable with the second connector 16C, which is located below the first connector 12C in the up-down direction, along the up-down direction. The first connector 12C mated with the second connector 16C is removable upward. The connector device 10C illustrated in FIG. 44 is in a mated state where the first connector 12C and the second connector 16C are mated with each other.

Comparing FIG. 44 with FIG. 3, the first connector 12C comprises a first holding member 14C different from the first holding member 14 of the first connector 12 and the first terminals 15 same as those of the first connector 12. The first holding member 14C has a predetermined side 24C which is different from the predetermined side 24 of the first holding member 14.

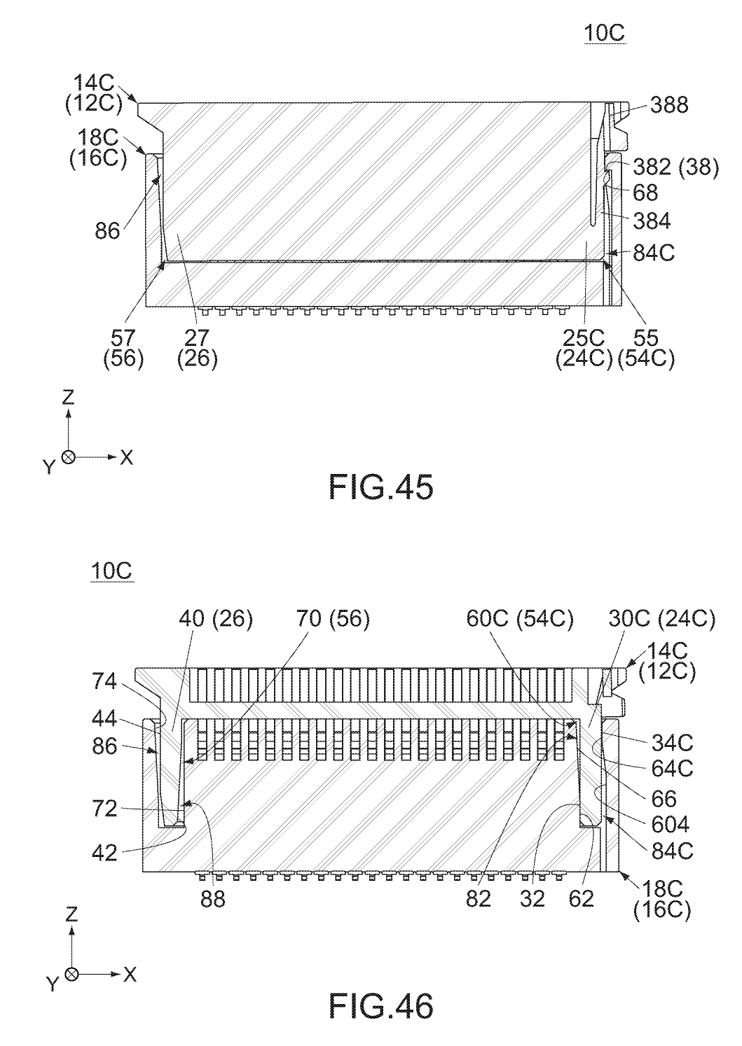

Referring to FIGS. 45 and 46 with FIGS. 5, 16 and 17, the predetermined side 24C has a base portion 25C different from the base portion 25 of the predetermined side 24 and two key portions 30C which are different from the two key portions 30 of the predetermined side 24, respectively. The two key portions 30C have a mirror-symmetric structure with respect to the vertical plane (XZ-plane) and work similarly to each other. The base portion 25C has a lower end which has a shape different from a shape of a lower end of the base portion 25. The base portion 25C has a structure same as that of the base portion 25 except for this difference and works similarly to the base portion 25. As described above, the first connector 12C has the key portions 30C different from the key portions 30 of the first connector 12. The first connector 12C has a structure similar to that of the first connector 12 except for this difference and works similarly to the first connector 12.

Comparing FIG. 44 with FIG. 3, the second connector 16C comprises a second holding member 18C different from the second holding member 18 of the second connector 16 and the second terminals 19 same as those of the second connector 16. The second holding member 18C is formed with a predetermined accommodation portion 54C which is different from the predetermined accommodation portion 54 of the second holding member 18. Referring to FIGS. 45 and 46 with FIGS. 9, 16 and 17, the predetermined accommodation portion 54C includes the base-receiving portion 55 same as that of the predetermined accommodation portion 54 and two key-receiving portions 60C which are different from the two key-receiving portions 60 of the predetermined accommodation portion 54, respectively. The two key-receiving portions 60C have a mirror-symmetric structure with respect to the vertical plane (XZ-plane) and work similarly to each other. As described above, the second connector 16C is formed with the key-receiving portions 60C different from the key-receiving portions 60 of the second connector 16. The second connector 16C has a structure same as that of the second connector 16 except for this difference and works similarly to the second connector 16.

Hereafter, explanation will be made about one of the two key portions 30C and one of the two key-receiving portions 60C which is configured to receive this key portion 30C. The explanation described below is applicable to a remaining one of the two key portions 30C and one of the two key-receiving portions 60C which is configured to receive this key portion 30C.

Referring to FIG. 46, the key portion 30C of the first connector 12C has the first inner straight 32 and a first outer straight 34C. The first inner straight 32 is located on an inner side of the key portion 30C in the width direction and linearly extends along the up-down direction. The first outer straight 34C is located on an outer side of the key portion 30C in the width direction and linearly extends along the up-down direction.

Comparing FIG. 46 with FIG. 17, the first outer straight 34C is longer than the first outer straight 34 in the up-down direction. In detail, the first outer straight 34C is the whole of an outer edge surface of the key portion 30C in the width direction and extends straight along the up-down direction from an upper end of the key portion 30C to a lower end of the key portion 30C. The key portion 30C is not provided with the outer intersecting portion 36. The key portion 30C has a structure same as that of the key portion 30 except for the aforementioned differences and works similarly to the key portion 30.

Referring to FIG. 46, the key-receiving portion 60C of the second connector 16C is provided with the second inner straight 62, a second outer straight 64C and the inner intersecting portion 66. The second inner straight 62 is located on an inner side of the key-receiving portion 60C in the width direction and linearly extends along the up-down direction. The second outer straight 64C is located on an outer side of the key-receiving portion 60C in the width direction and linearly extends along the up-down direction. The inner intersecting portion 66 extends upward and inward in the width direction from the upper end of the second inner straight 62.

Comparing FIG. 46 with FIG. 17, the second outer straight 64C is an upper part of the wall surface 604 and extends straight along the up-down direction from an upper end of the key-receiving portion 60C toward a lower end of the key-receiving portion 60C. The second outer straight 64C is shorter than the second outer straight 64. The key-receiving portion 60C has a structure same as that of the key-receiving portion 60 except for the aforementioned differences and works similarly to the key-receiving portion 60.

Referring to FIG. 46, in the mated state, the key-receiving portion 60C is formed with the upper space 82 and a lower space 84C located therein. Comparing FIG. 46 with FIG. 17, the upper space 82 of the present modification has a structure same as that of the upper space 82 of the key-receiving portion 60. The arrangement of the lower space 84C of the present modification is different from that of the lower space 84 of the key-receiving portion 60. More specifically, the lower space 84C is located between the first outer straight 34C of the first connector 12C and the wall surface 604 of the key-receiving portion 60C of the second connector 16C in the width direction. The lower space 84C can be formed by cutting off a part of a lower part of the wall surface 604 of the key-receiving portion 60C. The thus-shaped lower part of the key-receiving portion 60C is formed with a recess which is recessed outward in the width direction from the wall surface 604.

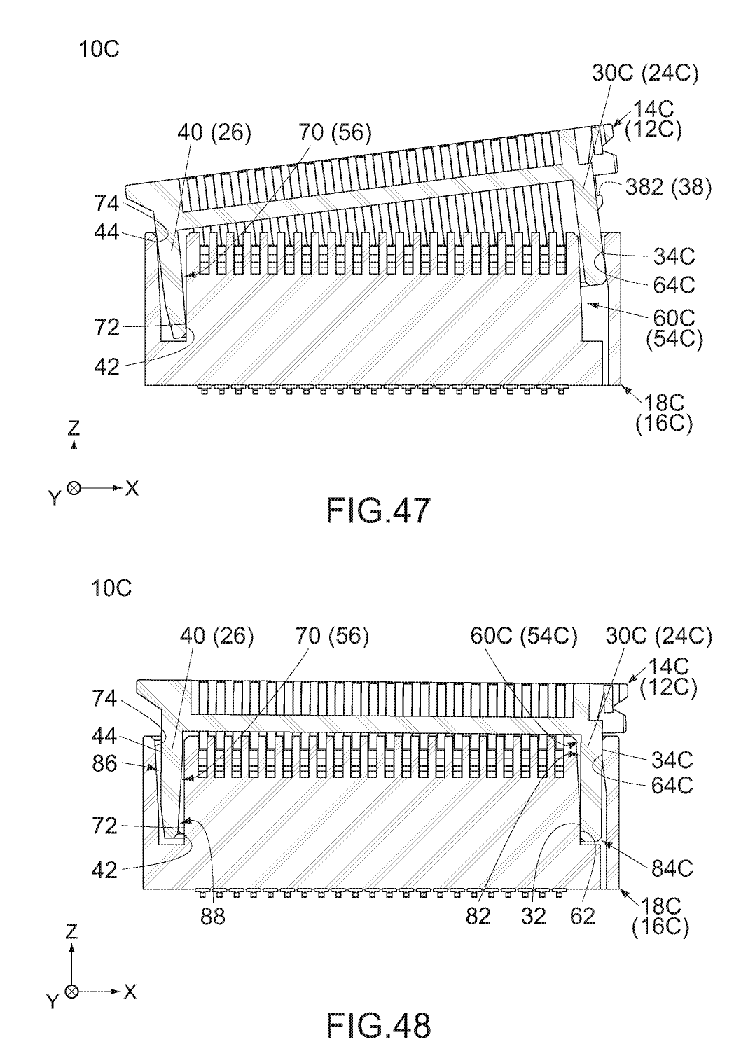

Comparing FIG. 48 with FIG. 22, according to the present modification, a turn of the first connector 12C around the locked side can be prevented similarly to the previously described embodiment. Comparing FIG. 47 with FIG. 20, the first connector 12C of the present modification can be turned around the free side similarly to the first connector 12. However, it is difficult to pull up the first connector 12C illustrated in FIG. 47 when the first connector 12C takes the illustrated posture. In other words, it is difficult to remove the first connector 12C of the present modification by the turning removal. According to the present modification, the first connector 12C illustrated in FIG. 47 can be removed from the second connector 16C as described below. Firstly, the free side of the first connector 12C is pulled upward so that the first connector 12C is turned to extend along the width direction. Then, the first connector 12C is moved upward.

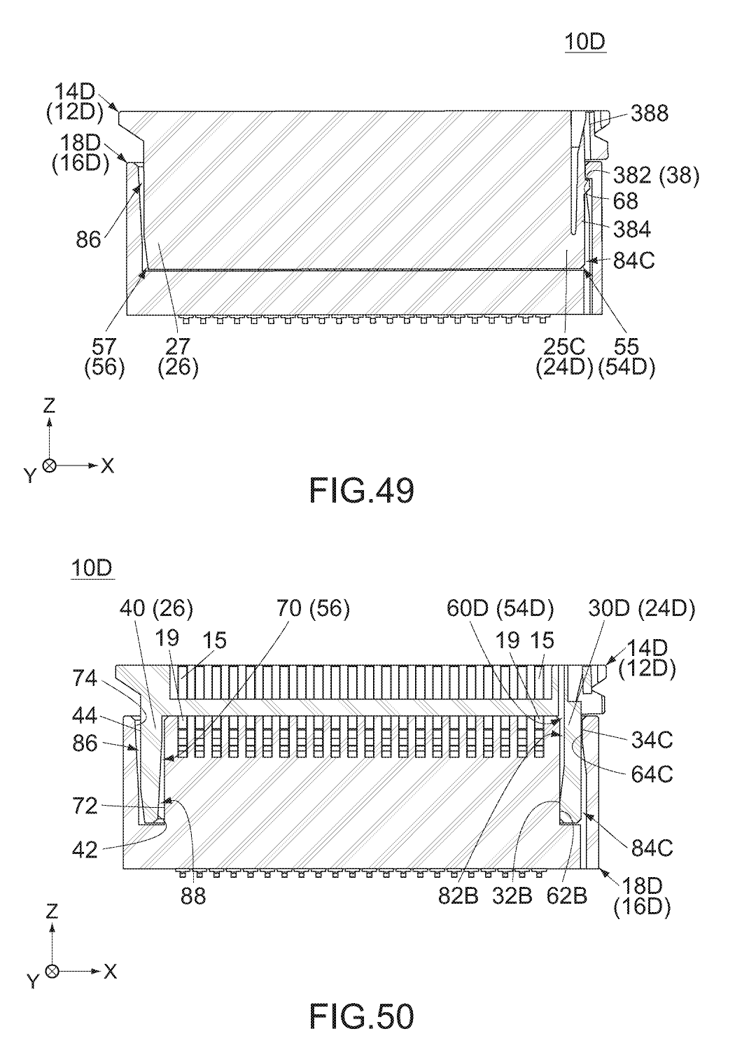

Referring to FIGS. 49 and 50, a connector device 10D according to a fourth modification comprises a first connector 12D and a second connector 16D. The connector device 10D illustrated in FIGS. 49 and 50 is in a mated state where the first connector 12D and the second connector 16D are mated with each other.

Comparing FIGS. 49 and 50 with FIGS. 45 and 46, the first connector 12D comprises a first holding member 14D different from the first holding member 14C of the first connector 12C and the first terminals 15 same as those of the first connector 12C. The first holding member 14D has a predetermined side 24D which is different from the predetermined side 24C of the first holding member 14C. The predetermined side 24D has the base portion 25C same as that of the predetermined side 24C and two key portions 30D which are different from the two key portions 30C of the predetermined side 24C, respectively. The two key portions 30D have a mirror-symmetric structure with respect to the vertical plane (XZ-plane) and work similarly to each other. As described above, the first connector 12D has the key portions 30D different from the key portions 30C of the first connector 12C. The first connector 12D has a structure same as that of the first connector 12C except for this difference and works similarly to the first connector 12C.

The second connector 16D comprises a second holding member 18D different from the second holding member 18C of the second connector 16C and the second terminals 19 same as those of the second connector 16C. The second holding member 18D is formed with a predetermined accommodation portion 54D which is different from the predetermined accommodation portion 54C of the second holding member 18C. The predetermined accommodation portion 54D includes the base-receiving portion 55 same as that of the predetermined accommodation portion 54C and two key-receiving portions 60D which are different from the two key-receiving portions 60C of the predetermined accommodation portion 54C, respectively. The two key-receiving portions 60D have a mirror-symmetric structure with respect to the vertical plane (XZ-plane) and work similarly to each other. As described above, the second connector 16D is formed with the key-receiving portions 60D different from the key-receiving portions 60C of the second connector 16C. The second connector 16D has a structure same as that of the second connector 16C except for this difference and works similarly to the second connector 16C.

Hereafter, explanation will be made about one of the two key portions 30D and one of the two key-receiving portions 60D which is configured to receive this key portion 30D. The explanation described below is applicable to a remaining one of the two key portions 30D and one of the two key-receiving portions 60D which is configured to receive this key portion 30D.

Comparing FIG. 50 with FIGS. 43 and 46, the key portion 30D of the first connector 12D has a structure which is a combination of an inner part of the key portion 30B of the first connector 12B in the width direction and an outer part of the key portion 30C of the first connector 12C in the width direction.

More specifically, the key portion 30D has the first inner straight 32B same as that of the key portion 30B and the first outer straight 34C same as that of the key portion 30C. The first inner straight 32B is located on an inner side of the key portion 30D in the width direction and linearly extends along the up-down direction. The first outer straight 34C is located on an outer side of the key portion 30D in the width direction and linearly extends along the up-down direction. The key portion 30D has a structure same as that of the key portion 30C except for the aforementioned differences and works similarly to the key portion 30C.

The key-receiving portion 60D of the second connector 16D has a structure which is a combination of an inner part of the key-receiving portion 60B of the second connector 16B in the width direction and an outer part of the key-receiving portion 60C of the second connector 16C in the width direction.

More specifically, the key-receiving portion 60D is provided with the second inner straight 62B same as that of the key-receiving portion 60B and the second outer straight 64C same as that of the key-receiving portion 60C. The second inner straight 62B is located on an inner side of the key-receiving portion 60D in the width direction and linearly extends along the up-down direction. The second outer straight 64C is located on an outer side of the key-receiving portion 60D in the width direction and linearly extends along the up-down direction. In the mated state, the key-receiving portion 60D is formed with the upper space 82B and the lower space 84C located therein. The upper space 82B of the key-receiving portion 60D has a structure same as that of the key-receiving portion 60B. The lower space 84C of the key-receiving portion 60D has a structure same as that of the key-receiving portion 60C. The key-receiving portion 60D has a structure same as that of the key-receiving portion 60C except for the aforementioned differences and works similarly to the key-receiving portion 60C.

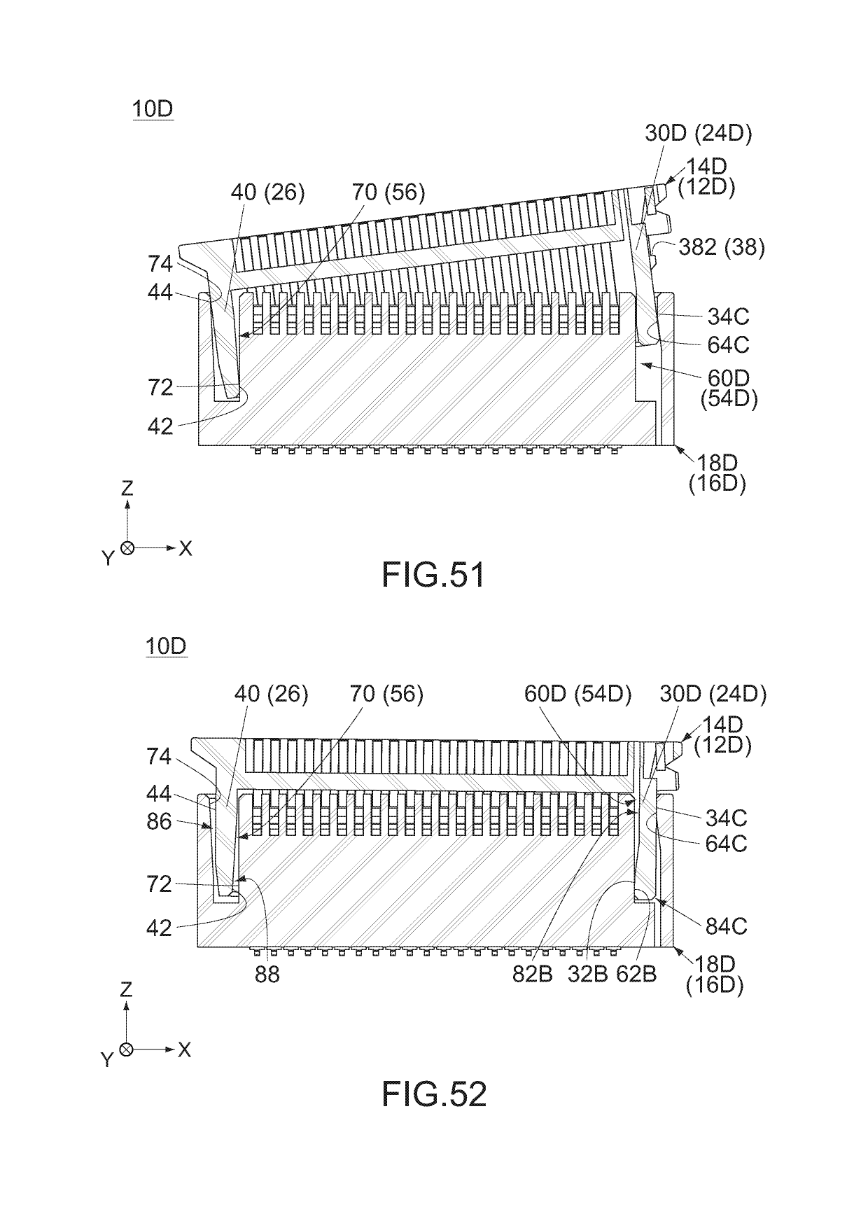

Comparing FIG. 52 with FIG. 48, according to the present modification, a turn of the first connector 12D around the locked side can be prevented similarly to the previously described third modification. Comparing FIG. 51 with FIG. 47, the first connector 12D of the present modification can be removed from the second connector 16D as described below similarly to the first connector 12C. Firstly, the first connector 12D is turned around the free side. Then, the free side of the first connector 12D is pulled upward so that the first connector 12D is turned to extend along the width direction.

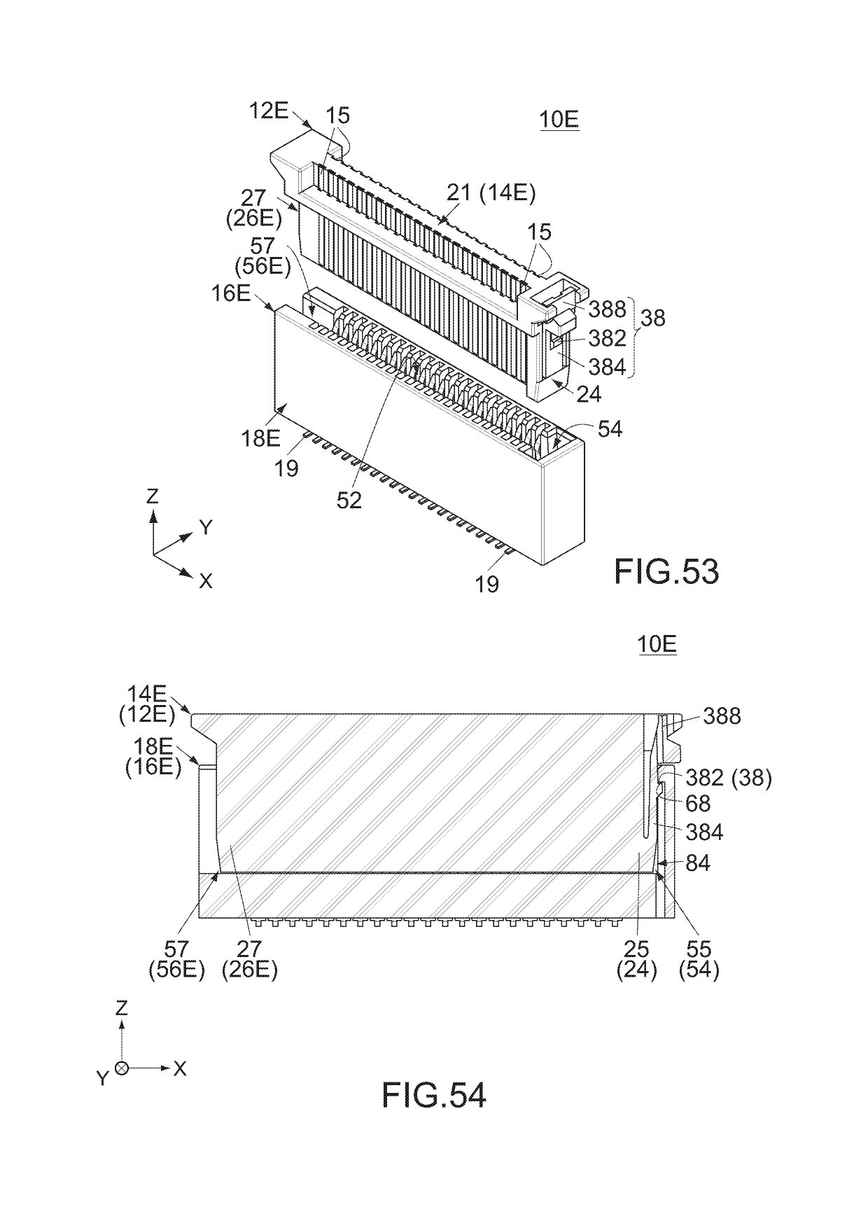

As shown in FIG. 53, a connector device 10E according to a fifth modification comprises a first connector 12E and a second connector 16E. The first connector 12E is mateable with the second connector 16E, which is located below the first connector 12E in the up-down direction, along the up-down direction. The first connector 12E mated with the second connector 16E is removable upward. The connector device 10E illustrated in FIG. 53 is in a separated state where the first connector 12E and the second connector 16E are separated from each other.

Comparing FIGS. 53-55 with FIGS. 3, 16 and 17, the first connector 12E comprises a first holding member 14E different from the first holding member 14 of the first connector 12 and the first terminals 15 same as those of the first connector 12. The first holding member 14E has an additional side 26E which is different from the additional side 26 of the first holding member 14. The additional side 26E has the additional base portion 27 same as that of the additional side 26 but does not have the additional key portions 40. The first connector 12E has a structure same as that of the first connector 12 except for the aforementioned differences and works similarly to the first connector 12.

The second connector 16E comprises a second holding member 18E different from the second holding member 18 of the second connector 16 and the second terminals 19 same as those of the second connector 16. The second holding member 18E does not have the end wall 185. The second holding member 18E is formed with an additional accommodation portion 56E which is different from the additional accommodation portion 56 of the second holding member 18. The additional accommodation portion 56E includes the additional base-receiving portion 57 same as that of the additional accommodation portion 56 but does not include the additional key-receiving portions 70 of the additional accommodation portion 56. The second connector 16E has a structure same as that of the second connector 16 except for the aforementioned differences and works similarly to the second connector 16.

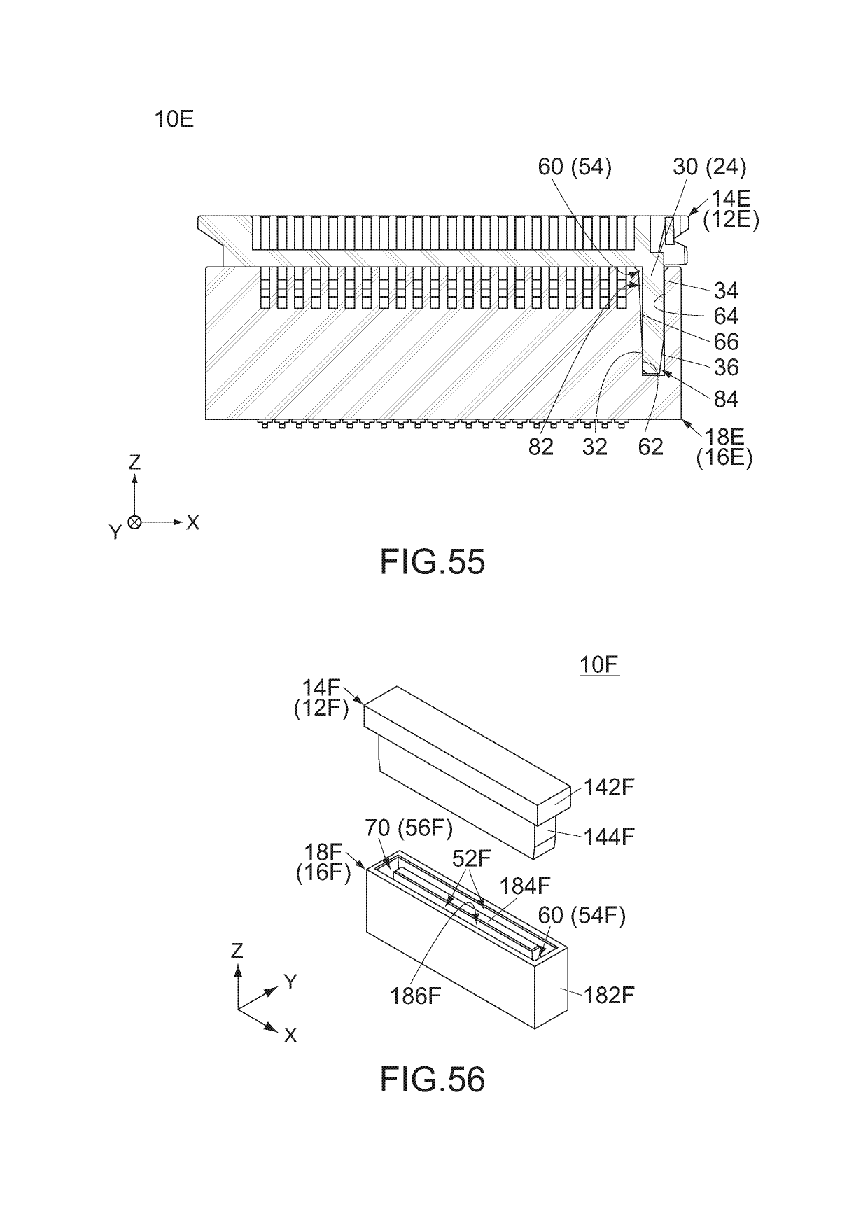

Referring to FIGS. 54 and 55 together with FIG. 22, according to the present modification, a turn of the first connector 12E around the locked side can be prevented similarly to the previously described embodiment. Referring to FIGS. 54 and 55 together with FIGS. 18 to 20, the first connector 12E of the present modification can be removed from the second connector 16 by the turning removal similarly to the first connector 12 while the turned angle is not limited within the predetermined angle θ.

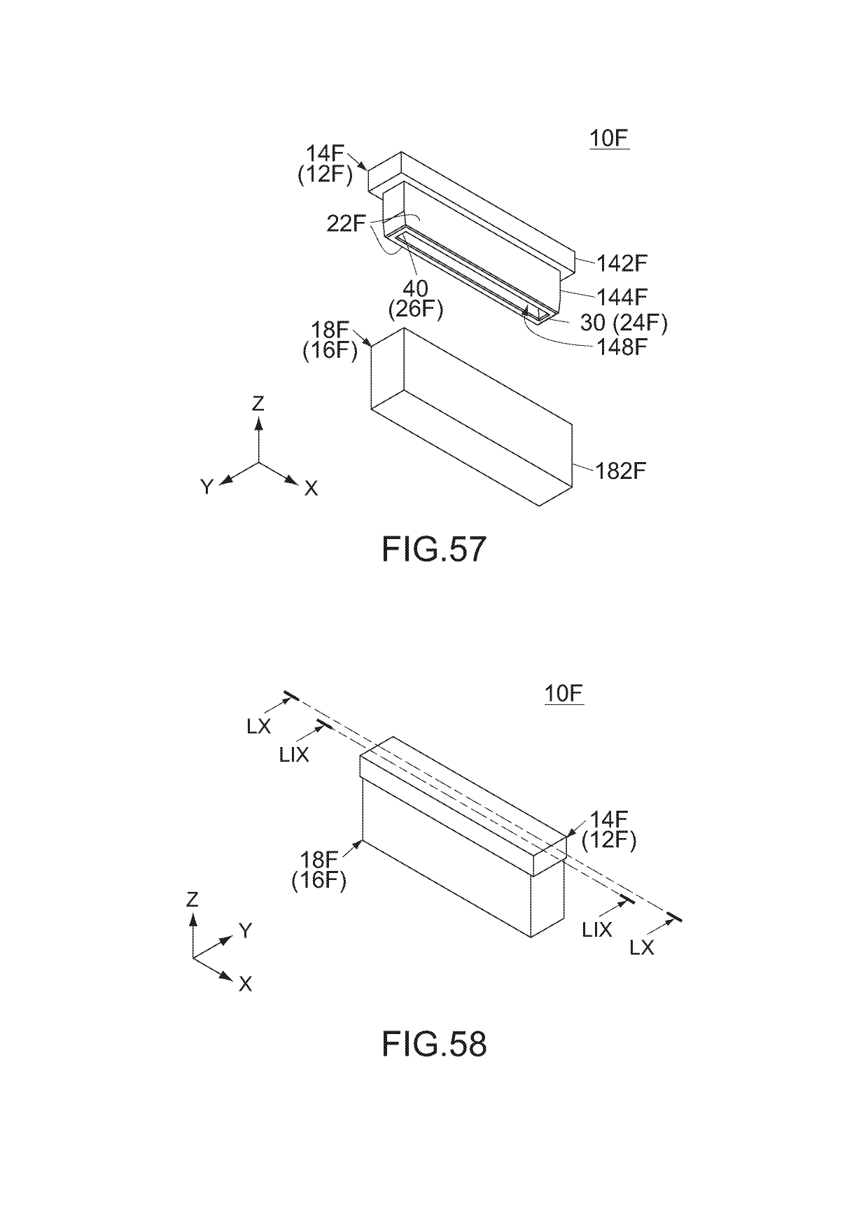

As shown in FIGS. 56-58, a connector device 10F according to a sixth modification comprises a first connector 12F and a second connector 16F. The first connector 12F is mateable with the second connector 16F, which is located below the first connector 12F in the up-down direction, along the up-down direction. The first connector 12F mated with the second connector 16F is removable upward. The connector device 10F illustrated in FIGS. 56 and 57 is in a separated state where the first connector 12F and the second connector 16F are separated from each other. The connector device 10F illustrated in FIG. 58 is in a mated state where the first connector 12F and the second connector 16F are mated with each other.

Referring to FIGS. 56 and 57, the first connector 12F of the present modification comprises a first holding member 14F made of insulator and first terminals (not shown) each made of conductor. The first holding member 14F has an upper wall 142F and a peripheral wall 144F. The peripheral wall 144F is formed with a receiving portion 148F located therein. The receiving portion 148F is located at the middle of the first connector 12F in the horizontal plane.

The peripheral wall 144F is divided into two main portions 22F, a predetermined side 24F and an additional side 26F. In other words, the first connector 12F has the two main portions 22F, the predetermined side 24F and the additional side 26F. Each of the main portions 22F extends along the vertical plane (XZ-plane). The main portions 22F have surfaces, respectively, each of which faces the receiving portion 148F in the thickness direction and holds the first terminals (not shown) arranged in the width direction. The predetermined side 24F and the additional side 26F are located at opposite ends of the peripheral wall 144F in the width direction, respectively, and sandwich the two main portions 22F in the width direction. The thus-arranged predetermined side 24F is located on one of opposite ends of the main portions 22F in the width direction. The additional side 26F is located on a remaining one of the opposite ends of the main portions 22F in the width direction.

The second connector 16F of the present modification comprises a second holding member 18F made of insulator and second terminals (not shown) each made of conductor. The second holding member 18F has an outer wall 182F and a middle wall 184F. The second holding member 18F is formed with a groove 186F located therein. The middle wall 184F is located at the middle of the second connector 16F in the horizontal plane. The groove 186F is a space which encloses the middle wall 184F in the horizontal plane. The outer wall 182F encloses the groove 186F in the horizontal plane.

The groove 186F is divided into two main accommodation portions 52F, a predetermined accommodation portion 54F and an additional accommodation portion 56F. In other words, the second connector 16F is formed with the main accommodation portions 52F, the predetermined accommodation portion 54F and the additional accommodation portion 56F. Each of the main accommodation portions 52F holds the second terminals (not shown) arranged in the width direction. The predetermined accommodation portion 54F is located on one of opposite ends of the main accommodation portions 52F in the width direction. The additional accommodation portion 56F is located on a remaining one of the opposite ends of the main accommodation portions 52F in the width direction.

In the mated state, the middle wall 184F of the second connector 16F is received in the receiving portion 148F of the first connector 12F, and the peripheral wall 144F of the first connector 12F is received in the groove 186F of the second connector 16F. Thus, the two main accommodation portions 52F of the second connector 16F are configured to accommodate the main portions 22F of the first connector 12F, respectively. The predetermined accommodation portion 54F of the second connector 16F is configured to accommodate the predetermined side 24F of the first connector 12F. The additional accommodation portion 56F of the second connector 16F is configured to accommodate the additional side 26F of the first connector 12F.

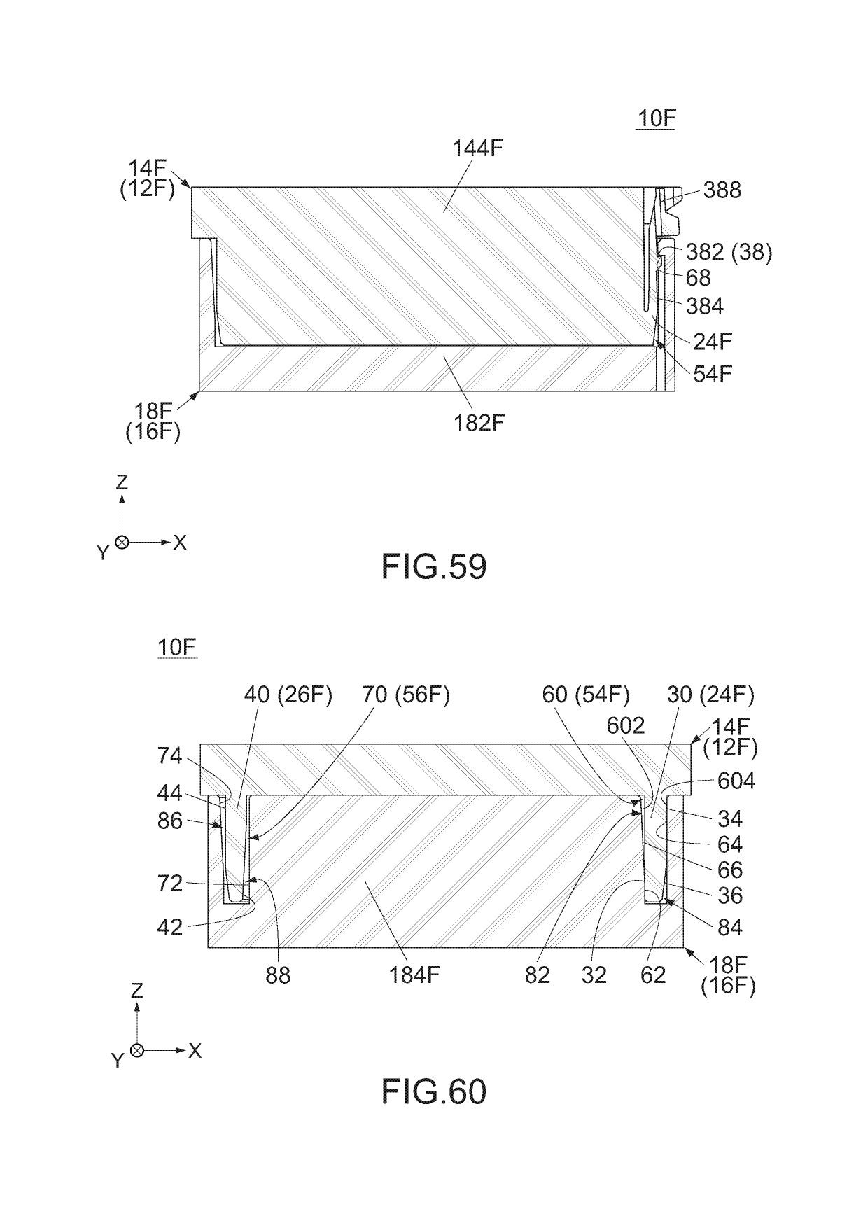

Comparing FIG. 59 with FIG. 16, the predetermined side 24F of the first connector 12F has the lock mechanism 38 (not shown in FIGS. 56-58) same as that of the first connector 12. The predetermined accommodation portion 54F of the second connector 16F is provided with the locked portion 68 same as that of the second connector 16. The locked portion 68 and the lock portion 382 of the lock mechanism 38 are together configured to lock the mated state of the first connector 12F. The lock mechanism 38 and the locked portion 68 illustrated in FIG. 59 are merely examples and can be modified as necessary.

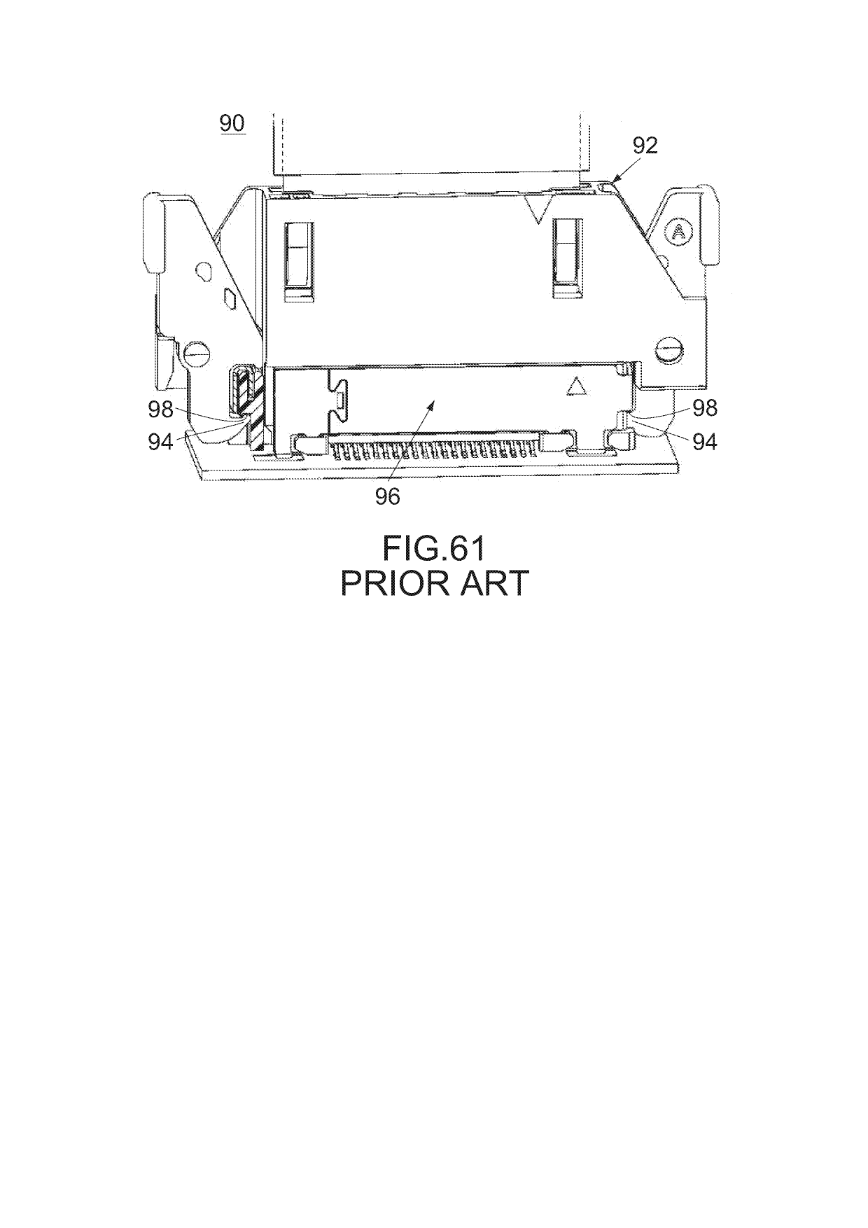

Comparing FIG. 60 with FIG. 17, the predetermined side 24F of the first connector 12F has the key portion 30 same as that of the first connector 12. According to the present modification, a part of the predetermined side 24F which is located at the middle of the predetermined side 24F in the thickness direction works as the key portion 30. Thus, the first connector 12F of the present modification has the only one key portion 30. The additional side 26F of the first connector 12F has the additional key portion 40 same as that of the first connector 12. According to the present modification, a part of the additional side 26F which is located at the middle of the additional side 26F in the thickness direction works as the additional key portion 40. Thus, the first connector 12F of the present modification has the only one additional key portion 40.

Referring to FIG. 60 together with FIG. 57, each of the key portion 30 and the additional key portion 40 of the present modification is located between the two main portions 22F in the thickness direction. Thus, each of the key portion 30 and the additional key portion 40 protrudes from each of the main portions 22F in the thickness direction.

Comparing FIG. 60 with FIG. 17, the predetermined accommodation portion 54F of the second connector 16F includes the key-receiving portion 60 same as that of the second connector 16. According to the present modification, a partial space of the predetermined accommodation portion 54F which is located at the middle of the predetermined accommodation portion 54F in the thickness direction works as the key-receiving portion 60. Thus, the second connector 16F of the present modification is formed with the only one key-receiving portion 60. The additional accommodation portion 56F of the second connector 16F includes the additional key-receiving portion 70 same as that of the second connector 16. According to the present modification, a partial space of the additional accommodation portion 56F which is located at the middle of the additional accommodation portion 56F in the thickness direction works as the additional key-receiving portion 70. Thus, the second connector 16F of the present modification is formed with the only one additional key-receiving portion 70.

Referring to FIG. 60 together with FIG. 56, each of the key-receiving portion 60 and the additional key-receiving portion 70 of the present modification is located between the two main accommodation portions 52F in the thickness direction. Thus, each of the key-receiving portion 60 and the additional key-receiving portion 70 protrudes from each of the main accommodation portions 52F in the thickness direction.

Referring to FIG. 60 together with FIG. 22, according to the present modification, a turn of the first connector 12F around the locked side can be prevented similarly to the previously described embodiment. Referring to FIG. 60 together with FIG. 20, the first connector 12F of the present modification can be turned around the free side similarly to the first connector 12. Accordingly, the first connector 12F can be easily removed by the turning removal.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector device comprising a first connector and a second connector, wherein:
the first connector is mateable with the second connector, which is located below the first connector in an up-down direction, along the up-down direction;
the first connector has a main portion and a predetermined side;
the main portion extends along a vertical plane defined by the up-down direction and a width direction perpendicular to the up-down direction;
the predetermined side is located on one of opposite ends of the main portion in the width direction;
the predetermined side has a key portion and a lock mechanism;
the key portion extends in the up-down direction and protrudes from the main portion in a thickness direction perpendicular to both the up-down direction and the width direction;
the key portion has a first inner straight and a first outer straight;
the first inner straight is located on an inner side of the key portion in the width direction and linearly extends along the up-down direction;
the first outer straight is located on an outer side of the key portion in the width direction and linearly extends along the up-down direction;
the first inner straight is at least partially located below the first outer straight;
the lock mechanism has a lock portion and a support portion which is resiliently deformable;
the support portion supports the lock portion;
the lock portion is movable at least in the width direction in accordance with resilient deformation of the support portion;
the second connector is formed with a main accommodation portion and a predetermined accommodation portion;
the main accommodation portion is configured to accommodate the main portion of the first connector;
the predetermined accommodation portion is configured to accommodate the predetermined side of the first connector;
the predetermined accommodation portion includes a key-receiving portion;
the key-receiving portion is configured to receive the key portion of the first connector;
the key-receiving portion is provided with a second inner straight and a second outer straight;
the second inner straight is located on an inner side of the key-receiving portion in the width direction and linearly extends along the up-down direction;
the second outer straight is located on an outer side of the key-receiving portion in the width direction and linearly extends along the up-down direction;
the second outer straight is at least partially located above the second inner straight;
the predetermined accommodation portion is provided with a locked portion;
the locked portion and the lock portion are together configured to lock a mated state where the first connector and the second connector are mated with each other;
in the mated state, the first inner straight and the second inner straight are in contact with each other or face each other in the width direction, and the first outer straight and the second outer straight are in contact with each other or face each other in the width direction;
in the mated state, the key-receiving portion is formed with an upper space and a lower space located therein;
the upper space is located inward of the key portion in the width direction and is located above at least one of the first inner straight and the second inner straight;
the upper space has a size in the width direction which is larger than a distance between the first inner straight and the second inner straight;
the lower space is located outward of the key portion in the width direction and is located below at least one of the first outer straight and the second outer straight; and
the lower space has a size in the width direction which is larger than a distance between the first outer straight and the second outer straight.

2. The connector device as recited in claim 1, wherein the upper space and the lower space are located at positions, respectively, which are partially same as each other in the up-down direction.

3. The connector device as recited in claim 1, wherein the key portion of the first connector includes two key portions which protrude from opposite sides of the main portion in the thickness direction, respectively.

4. The connector device as recited in claim 1, wherein:
the key portion of the first connector has an outer intersecting portion;
the outer intersecting portion extends downward and inward in the width direction from a lower end of the first outer straight; and
the lower space is located between the outer intersecting portion and a wall surface of the key-receiving portion of the second connector in the width direction.

5. The connector device as recited in claim 4, wherein:
the key-receiving portion of the second connector is provided with an inner intersecting portion;
the inner intersecting portion extends upward and inward in the width direction from an upper end of the second inner straight; and
the upper space is located between the inner intersecting portion and the key portion of the first connector in the width direction.

6. The connector device as recited in claim 1, wherein:
the first connector has an additional side;
the additional side is provided with a projecting portion;
the projecting portion projects outward in the width direction from the additional side;
the second connector is formed with an additional accommodation portion;
the additional accommodation portion is provided with a facing portion;
in the mated state, the facing portion is located above the projecting portion and faces the projecting portion in the up-down direction; and
when the key portion of the first connector in the mated state is moved upward so that the first connector is turned by a predetermined angle relative to the second connector, the projecting portion is moved to a position which is different from a position of the facing portion in the width direction and thereby does not face the facing portion in the up-down direction.

7. The connector device as recited in claim 1, wherein:
the first connector has an additional side;
the additional side has an additional key portion;
the second connector is formed with an additional accommodation portion;
the additional accommodation portion is configured to accommodate the additional side;
the additional accommodation portion includes an additional key-receiving portion;
the additional key-receiving portion is configured to receive the additional key portion;
in the mated state, the additional key-receiving portion is formed with an additional upper space and an additional lower space located therein;
the additional upper space is located outward of the additional key portion in the width direction;
the additional lower space is located inward of the additional key portion in the width direction; and
the additional lower space is at least partially located below the additional upper space.

8. The connector device as recited in claim 7, wherein:
the additional key portion has an inner abutment portion and an outer abutment portion;
the inner abutment portion is located on an inner side of the additional key portion in the width direction;
the outer abutment portion is located on an outer side of the additional key portion in the width direction;
the inner abutment portion is located below the outer abutment portion;
the additional key-receiving portion is provided with an inner stopper and an outer stopper which correspond to the inner abutment portion and the outer abutment portion, respectively; and
when the key portion of the first connector in the mated state is moved upward so that the first connector is turned by a predetermined angle relative to the second connector, at least one of the inner abutment portion and the outer abutment portion is brought into abutment with a corresponding one of the inner stopper and the outer stopper, and thereby a turn beyond the predetermined angle is prevented.

9. The connector device as recited in claim 3, wherein:
the lock mechanism is located between the two key portions in the thickness direction;
the support portion is a cantilever which extends from a fixed end; and
the support portion has a free end which is located above the fixed end of the support portion.
